(19) United States
(12) Patent Application Publication
(10) Pub. No.: US 2008/0241524 A1
(43) Pub. Date: Oct. 2, 2008

(54) Protective Film, Polarizing Plate, and Liquid Crystal Display Device

(75) Inventors: Kenichi Fukuda, Minami-Ashigara-shi (JP); Katsumi Inoue, Minami-Ashigara-shi (JP); Hiroyuki Yoneyama, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/057,921

(22) Filed: Mar. 28, 2008

(30) Foreign Application Priority Data
Mar. 29, 2007 (JP) 2007-089734

(51) Int. Cl. B32B 7/00

(52) U.S. Cl. 428/336

(57) ABSTRACT

The present invention provides a protective film which achieves high surface hardness and low moisture permeability, a polarizing plate using the protective film, and a liquid crystal display device having a high surface hardness and excellent durability using the polarizing plate. The protective film of the present invention contains a low moisture-permeable layer and a hard coat layer having an average thickness of 10 μm or more, which are laminated in that order over one surface of a transparent substrate film, and has a moisture permeability at 60° C. and 95% relative humidity of 500 g/m² per day or less.

### BACKGROUND OF THE INVENTION

1. Field of the Invention

The present invention relates to a protective film which achieves high surface hardness and low moisture permeability, and to a polarizing plate and a liquid crystal display device using the protective film, and more particularly relates to a protective film having a low moisture-permeable layer and a hard coat layer having a thickness of 10 μm or more, and to a polarizing plate and a liquid crystal display device using the protective film.

2. Description of the Related Art

Antireflection films such as an anti-glare hard coat layer laminated over a transparent plastic film substrate (in which case it is also called an anti-glare film), or a hard coat layer and a low-reflection layer laminated over a transparent plastic film substrate, are disposed over the surface of displays in liquid crystal display devices (LCDs), plasma display panels (PDPs), electroluminescent displays (ELDs), cathode ray tube display devices (CRTs), and various other such liquid crystal display devices to prevent a decrease in contrast due to the reflection of external light or to image ghosting, by means of surface scattering or low surface reflection.

As the prices of liquid crystal televisions and so forth have dropped in recent years, image display devices using antireflection films have become popular. Because of this trend, antireflection films are increasingly being exposed to various environments along with the image display devices in which they are installed. In particular, they are treated as if they were CRT televisions, which have glass surfaces, so there is greater risk that the surface of the liquid crystal display device will be scratched. Consequently, an antireflection film installed on the outermost surface of a liquid crystal display device not only needs to improve visibility as has been required in the past, but also needs to have high physical strength (scratch resistance, etc.).

To obtain higher physical strength, there has been proposed an antireflection film in which a hard coat layer having a thickness of 10 μm or more is laminated by coating a cellulose acylate film with a curable composition containing a photocurable resin and an organic solvent, and drying and photocuring the coating (see Japanese Patent Application laid-Open (JP-A) No. 2003-227902).

There has also been proposed an anti-glare film that has high surface hardness and that is the product of laminating an anti-glare layer having a thickness of 15 μm to 35 μm by coating a cellulose acylate film with a curable composition containing resin particles having an average particle diameter of 6 μm to 15 μm, a curable resin, and an organic solvent, and then drying and photocuring the coating (see JP-A No. 2007-041533).

Meanwhile, with a liquid crystal television, a configuration is adopted in which two polarizing plates are disposed over either side of a liquid crystal cell. These polarizing plates usually have cellulose acylate films disposed, via an adhesive agent, on both sides of a polarizing layer whose main component is polyvinyl alcohol, as protective films for polarizing plate.

With a liquid crystal display device containing polarizing plates in which cellulose acylate films are used as protective films, when the device is used for an extended period under a harsh environment, there may be inconsistency in the displayed image due to changes in the size of the polarizing layer brought about by changes in temperature or humidity. As liquid crystal televisions have become more popular as mentioned above, there is greater likelihood that the liquid crystal television will be used under a harsh environment, so improvement is needed in this area.

To solve these problems, it has been proposed that the wet heat resistance of a polarizing plate can be improved by using a protective film in which a low moisture-permeable layer containing a vinylidene chloride copolymer is provided over the surface of a cellulose acylate film (see JP-A Nos. 62-161103 and 2001-215331).

However, there had up to now been no proposal for a protective film (antireflection film) that achieves high surface hardness and low moisture permeability.

One possible way to solve the above problems at the same time is to combine the above-mentioned two techniques to obtain surface hardness and low moisture permeability. Specifically, this is a method of laminating a low moisture permeability hard coat layer by laminating a low moisture-permeable layer containing a vinylidene chloride copolymer and a hard coat layer of 10 μm or more over a substrate film.

Nevertheless, studies by the inventors have revealed that when a curable resin composition containing an organic solvent is used to laminate a hard coat layer having a thickness of 10 μm or more over a film provided with a low moisture-permeable layer containing a vinylidene chloride copolymer, the problem is that permeability rises and sufficiently low moisture permeability cannot be obtained.

Also, the studies conducted by the inventors revealed that when a curable resin composition containing resin particles, a curable resin, and an organic solvent is used to laminate an anti-glare hard coat layer having a thickness of 10 μm or more over a film provided with a low moisture-permeable layer containing a vinylidene chloride copolymer, in addition to the problem of increased moisture permeability, the resin particles end up migrating to the side away from the substrate, which is a problem in that the surface scattering becomes too high.

### BRIEF SUMMARY OF THE INVENTION

It is an object of the present invention to solve the above problems encountered in the past, and to achieve the following. Specifically, it is an object of the present invention to provide a protective film that achieves high surface hardness and low moisture permeability, a polarizing plate using the protective film, and a liquid crystal display device that makes use of the polarizing plate and has high surface hardness and reduced light leakage.

To solve the above problems, the inventors conducted diligent research, and as a result found the following. To laminate a thick hard coat layer, a thick coating of curable composition has to be applied, so the coating amount of organic solvent contained in the curable composition necessarily increases, but this organic solvent penetrates into the low moisture-permeable layer and dissolves the low moisture-permeable layer. In light of this, the inventors found that the above problems could be solved by setting the thickness of the hard coat layer to 10 μm or more, and controlling the moisture permeability at 60° C. and a 95% relative humidity after the hard coat layer has been laminated to be 500 g/m² per day or less.

The present invention is based on the above findings of the inventors, and the means for solving the above-mentioned problems are as follows. Specifically, a protective film of the present invention containing a transparent substrate film, a low moisture-permeable layer over one surface of the transparent substrate film and a hard coat layer over the low moisture-permeable layer, the hard coat layer having an average thickness of 10 μm or more, wherein the protective film has a moisture permeability at 60° C. and 95% relative humidity of 500 g/m² per day or less.

A polarizing plate of the present invention containing a polarizer and a protective film provided over at least one surface of the polarizer, wherein the protective film contains a transparent substrate film, a low moisture-permeable layer over one surface of the transparent substrate film and a hard coat layer over the low moisture-permeable layer, the hard coat layer having an average thickness of 10 μm or more, wherein the protective film has a moisture permeability at 60° C. and 95% relative humidity of 500 g/m² per day or less.

A liquid crystal display device containing a liquid crystal cell and a polarizing plate containing a polarizer and a protective film provided over at least one surface of the polarizer, wherein the protective film contains a transparent substrate film, a low moisture-permeable layer over one surface of the transparent substrate film, and a hard coat layer over the low moisture-permeable layer, the hard coat layer having an average thickness of 10 μm or more, wherein the protective film has a moisture permeability at 60° C. and 95% relative humidity of 500 g/m² per day or less.

### DETAILED DESCRIPTION OF THE INVENTION

A protective film, polarizing plate, and liquid crystal display device of the present invention will now be described in detail.

### (Protective Film)

The protective film of the present invention contains at least a low moisture-permeable layer and a hard coat layer having a thickness of 10 μm or more laminated in that order over a transparent substrate film. There may be a plurality of these hard coat layers, in which case the “average thickness” of the hard coat layer in the present invention means the total of the average thickness of all the hard coat layers.

The thickness of each layer can be found by observing a cross section of the film. This cross sectional observation is preferably accomplished by observing a cross section of the film with a scanning electron microscope. When the hard coat layer is laminated over the low moisture-permeable layer, the low moisture-permeable layer and the hard coat layer may mix at their interface, making it hard to distinguish the interface between the low moisture-permeable layer and the hard coat layer. With this in mind, the “average thickness” of the hard coat layer in the present invention refers to the thickness obtained by subtracting the average thickness when just the low moisture-permeable layer is laminated from the average thickness obtained by combining the low moisture-permeable layer and the hard coat layer after the lamination of the hard coat layer.

Also, the effect of the present invention is particular good when the hard coat layer contains fine particles. When a curable composition containing fine particles, a curable resin, and a organic solvent is used to laminate a hard coat layer having a thickness of 10 μm or more over a substrate film provided with a low moisture-permeable layer, then in addition to the problem of not being able to obtain sufficiently low moisture permeability, the resin particles end up migrating to the side away from the substrate, and when the fine particles are added for the purpose of achieving surface scattering, then this uneven distribution of the fine particles will result in an increase in surface scattering. This also leads to a decrease in the thickness of the layer containing the fine particles, and an increase in the thickness of the portion where the fine particles and the low moisture-permeable layer are not contained.

To solve these problems, with a film in which a low moisture-permeable layer and a hard coat layer containing fine particles are laminated in that order over one side of a transparent substrate film, it is preferable to keep the average thickness of the portion where fine particles are not contained between 0.3 μm and 3.0 μm from the interface between the transparent substrate film and the low moisture-permeable layer. It is more preferable for the above-mentioned thickness to be between 0.5 μm and 2.5 μm, and a range of 0.7 μm to 2.0 μm is particularly favorable.

In the present invention, the “particle-free layer thickness,” which is the average thickness of the portion where fine particles are not contained, is measured by observing a cross section with a scanning electron microscope. The specific measurement method is discussed in (5) Particle-Free Layer Thickness in the section titled “Evaluation of Anti-Glare Hard Coat Film” in “Examples”.

An antistatic layer (used, for example, when it is necessary to lower the surface resistance from the display side, or when the adherence of dirt on the surface or elsewhere is a problem), an adhesion improving layer, an interference fringe-preventing layer (used when there is a refractive index difference of 0.03 or more between the substrate and the hard coat layer, or the like may be provided as needed between the transparent substrate film and the hard coat layer. As long as these layers are provided between the transparent substrate film and the hard coat layer, they may be between the substrate film and the low moisture-permeable layer, or between the low moisture-permeable layer and the hard coat layer.

Moreover, providing an antireflection layer containing one or more layers including a low-refractive index layer on the side of the hard coat layer away from the transparent substrate film is a preferred mode.

Preferred examples of the layer configuration will be given below, but the present invention is not limited to the following configurations.

substrate film, low moisture-permeable layer, hard coat layer

substrate film, low moisture-permeable layer, hard coat layer, low-refractive index layer

substrate film, low moisture-permeable layer, hard coat layer, high-refractive index layer, low-refractive index layer

substrate film, low moisture-permeable layer, hard coat layer, middle refractive index layer, high-refractive index layer, low-refractive index layer

substrate film, low moisture-permeable layer, anti-glare hard coat layer

substrate film, low moisture-permeable layer, anti-glare hard coat layer, low-refractive index layer

The moisture permeability of the protective film of the present invention at 60° C. and 95% relative humidity is preferably 500 g/m² per day or less, more preferably 400 g/m² per day or less, and even more preferably 300 g/m² per day or less.

Setting the moisture permeability to 500 g/m² per day or less suppresses changes in the size of the polarizing layer of the liquid crystal display device in which the protective film is provided.

Moreover, the above-mentioned moisture permeability is preferably 50 g/m² per day or more, more preferably 80 g/m² per day or more, and even more preferably 100 g/m² per day or more. Setting the moisture permeability to 50 g/m² per day or more allows moisture to be released efficiently in the drying step during processing of the polarizing plate.

Here, the method for measuring the above-mentioned moisture permeability can be the method described in “Physical Properties of Polymer [Kouhunshi no Bussei] II,” (Polymer Experiment Course [Kouhunshi Jikken Kouza] 4, Kyoritsu Shuppan Co., Ltd.), pp. 285-294: Measurement of Vapor Penetration Amount (mass method, thermometer method, vapor pressure method, adsorption method). A film sample that is 70 mm in diameter is conditioned for moisture for 24 hours at 60° C. and 95% relative humidity, and the moisture content per unit of surface area (g/m²) is calculated from the mass difference before and after moisture conditioning according to JIS Z 0208.

The moisture permeability of a commercially available cellulose acylate film measured by the above method is generally 1,400 g/m² per day to 1,500 g/m² per day (the moisture permeability under the above conditions at a thickness of 80 μm).

### <<Transparent Substrate Film>>

The optical transmissivity of the transparent substrate film is preferably 80% or more, and more preferably 86% or more.

In the present invention, the optical transmissivity of the transparent substrate film is found by using a spectrometer to take measurements every 1 nm in a wavelength range of from 380 nm to 780 nm, and calculating the average value.

The haze of the transparent substrate film is preferably 2.0% or less, and more preferably 1.0% or less.

Haze is measured on an optical compensation film sample measuring 40 mm×80 mm by a haze meter (HGM-2DP, made by Suga Test Instruments) at 25° C. and 60% RH, according to JIS K 6714.

The refractive index of the transparent substrate film is preferably from 1.4 to 1.7.

The refractive index of the transparent substrate film can be measured with an Abbe refractometer (DR-1A manufactured by Atago Co., Ltd.), using a sodium lamp as a light source.

Examples of the materials of the transparent substrate film include cellulose ester, polyamide, polycarbonate, polyester (such as polyethylene terephthalate, polyethylene naphthalate, poly-1,4-cyclohexanedimethylene terephthalate, polyethylene-1,2-diphenoxyethane-4,4′-dicarboxylate, and polybutylene terephthalate), polystyrene (such as syndiotactic polystyrene), polyolefin (such as polypropylene, polyethylene, or polymethylpentene), polysulfone, polyether sulfone, polyallylate, polyether imide, polymethyl methacrylate, and polyether ketone. Cellulose ester, polycarbonate, polyethylene terephthalate, and polyethylene naphthalate are preferred.

### [Cellulose Acylate Film]

A cellulose acylate film is preferably used as the transparent substrate film. Cellulose acylate is produced by the esterification of cellulose. For example, at least one of linter, kenaf, and pulp is refined and used as the cellulose before esterification.

### —Cellulose Acylate—

The term “cellulose acylate” as used in the present invention means a fatty acid ester of cellulose, with a lower fatty acid ester being preferred, and a fatty acid ester film of cellulose being particularly preferred.

“Lower fatty acid” here means a fatty acid having six or fewer carbon atoms. A cellulose acylate having two to four carbon atoms is preferred, and cellulose acetate is particularly preferred. It is also preferable to use a mixed fatty acid ester such as cellulose acetate propionate or cellulose acetate butyrate.

The viscosity average degree of polymerization (Dp) of the cellulose acylate is preferably 250 or more, and more preferably 290 or more.

Moreover, the molecular mass distribution of the cellulose acylate, indicated by Mw/Mn (where Mw is a mass average molecular mass and Mn is a number average molecular mass) according to gel permeation chromatography, is preferably narrow. Specifically, the Mw/Mn value is preferably from 1.0 to 5.0, more preferably from 1.0 to 3.0, and even more preferably from 1.0 to 2.0.

A cellulose acylate having a degree of acetylation of 55.0% to 62.5% is preferably used as the transparent substrate film.

The degree of acetylation is more preferably 57.0% to 62.0%, and even more preferably 59.0% to 61.5%.

The term “degree of acetylation” means the amount of acetic acid bonded per unit mass of cellulose.

The degree of acetylation can be found by measurement and calculation of a degree of acylation as set forth in ASTM D-817-91 (Test Method for Cellulose Acylate, etc.).

In the cellulose acylate, the hydroxyls are not uniformly substituted at the 2-, 3- and 6-positions of the cellulose, and the degree of substitution at the 6-position tends to be lower.

With the cellulose acylate used in the present invention, the degree of substitution at the 6-position of the cellulose is preferably equal to or greater than that at the 2- or 3-position. The ratio of the degree of substitution at the 6-position to the total degree of substitution at the 2-, 3-, and 6-positions is preferably from 30% to 40%, more preferably from 31% to 40%, and even more preferably from 32% to 40%.

Various additives may be used in the transparent substrate film to adjust the mechanical properties of the film (such as film strength, curl, dimensional stability, and slip) and durability (such as wet heat resistance and weather resistance). Examples of additives include plasticizers (such as phosphoric acid esters, phthalic acid esters, and esters of a polyol and a fatty acid), UV blockers (such as hydroxybenzophenone compounds, benzotriazole compounds, salicylic acid ester compounds, and cyanoacrylate compounds), anti-aging agents (such as antioxidants, peroxide decomposers, radical inhibitors, metal inactivators, acid scavengers, and amines), fine particles (such as SiO₂, Al₂O₃, TiO₂, BaSO₄, CaCO₃, MgCO₃, talc, and kaolin), parting agents, antistatic agents, and infrared absorbents.

The materials of the above-mentioned transparent substrate film are described in detail in Japan Institute of Invention and Innovation Technical Disclosure No. 2001-1745, pp. 17-22 (issued Mar. 15, 2001, JIII).

The amount in which the above additives are used is preferably from 0.01 mass % to 20 mass %, and more preferably from 0.05 mass % to 10 mass % in the transparent support.

### <<Low Moisture-Permeable Layer>>

The low moisture-permeable layer is preferably a coat layer formed from a compound containing chlorine. In this case, the coat layer is preferably a resin having repeating units derived from a chlorine-containing vinyl monomer. Typical examples of chlorine-containing vinyl monomers are vinyl chloride and vinylidene chloride. Of these, vinylidene chloride is particularly preferable.

The above-mentioned chlorine-containing monomer can be obtained by copolymerizing vinyl chloride or vinylidene chloride with a copolymerizable monomer.

—Monomers Copolymerized with a Chlorine-Containing Vinyl Monomer—

Examples of the copolymerizable monomers include monomers selected from olefins, styrenes, acrylic acid esters, methacrylic acid esters, acrylamides, methacrylamides, itaconic acid esters, maleic acid esters, fumaric acid diesters, N-alkylmaleimides, maleic anhydride, acrylonitrile, vinyl ethers, vinyl esters, vinyl ketones, vinyl heterocyclic compounds, glycidyl esters, unsaturated nitriles, and unsaturated carboxylic acids.

Examples of the olefins include dicyclopentadiene, ethylene, propylene, 1-butene, 1-pentene, isoprene, chloroprene, butadiene, and 2,3-dimethylbutadiene.

Examples of the styrenes include styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, trifluoromethylstyrene, and methyl vinylbenzoate.

Specific examples of the acrylic acid esters and methacrylic acid esters include methyl acrylate, ethyl acrylate, propyl acrylate, butyl acrylate, amyl acrylate, 2-ethylhexyl acrylate, octyl acrylate, t-octyl acrylate, 2-methoxyethyl acrylate, 2-butoxyethyl acrylate, 2-phenoxyethyl acrylate, chloroethyl acrylate, cyanoethyl acrylate, dimethylaminoethyl acrylate, benzyl acrylate, methoxybenzyl acrylate, furfuryl acrylate, phenyl acrylate, methyl methacrylate, ethyl methacrylate, propyl methacrylate, isopropyl methacrylate, butyl methacrylate, amyl methacrylate, hexyl methacrylate, 2-ethylhexyl methacrylate, octyl methacrylate, benzyl methacrylate, cyanoacetoxyethyl methacrylate, chlorobenzyl methacrylate, sulfopropyl methacrylate, N-ethyl-N-phenylaminoethyl methacrylate, 2-methoxyethyl methacrylate, 2-(3-phenylpropyloxy)ethyl methacrylate, dimethylaminophenoxyethyl methacrylate, furfuryl methacrylate, tetrahydrofurfuryl methacrylate, phenyl methacrylate, cresyl methacrylate, naphthyl methacrylate, hydroxyethyl acrylate, hydroxyethyl methacrylate, hydroxypropyl acrylate, hydroxypropyl methacrylate, 3-chloro-2-hydroxypropyl methacrylate, 2,2-dimethylhydroxypropyl acrylate, 5-hydroxypentyl acrylate, diethylene glycol monoacrylate, trimethylolpropane monoacrylate, pentaerythritol monoacrylate, 2,2-dimethyl-3-hydroxypropyl methacrylate, 5-hydroxypropyl methacrylate, diethylene glycol monomethacrylate, trimethylolpropane monomethacrylate, and pentaerythritol monomethacrylate.

Specific examples of the vinyl ethers include methyl vinyl ether, butyl vinyl ether, hexyl vinyl ether, octyl vinyl ether, decyl vinyl ether, ethyl hexyl vinyl ether, methoxyethyl vinyl ether, ethoxyethyl vinyl ether, chloroethyl vinyl ether, 1-methyl-2,2-dimethylpropyl vinyl ether, 2-ethyl butyl ether, dimethylaminoethyl vinyl ether, diethylaminoethyl vinyl ether, butylaminoethyl vinyl ether, benzylvinyl ether, tetrahydrofurfuryl vinyl ether, vinyl phenyl ether, vinyl tolyl ether, vinyl chlorophenyl ether, vinyl-2,4-dichlorophenyl ether, vinyl naphthyl ether, and vinyl anthranyl ether.

Specific examples of the vinyl esters include vinyl acetate, vinyl propionate, vinyl butyrate, vinyl isobutyrate, vinyl dimethyl propionate, vinyl ethyl butyrate, vinyl valerate, vinyl caproate, vinyl chloroacetate, vinyl dichloroacetate, vinyl methoxyacetate, vinyl butoxyacetate, vinyl phenyl acetate, vinyl acetoacetate, vinyl lactate, vinyl-β-phenyl butyrate, vinyl cyclohexyl carboxyl ate, vinyl benzoate, vinyl salicylate, vinyl chlorobenzoate, vinyl tetrachlorobenzoate, and vinyl naphthoate.

Examples of the acrylamides include acrylamide, methyl acrylamide, ethyl acrylamide, propyl acrylamide, butyl acrylamide, t-butyl acrylamide, cyclohexyl acrylamide, benzyl acrylamide, hydroxymethyl acrylamide, methoxyethyl acrylamide, dimethylaminoethyl acrylamide, phenyl acrylamide, dimethyl acrylamide, diethyl acrylamide, β-cyanoethyl acrylamide, and N-(2-acetoacetoxyethyl) acrylamide.

Examples of the methacrylamides include methacrylamide, methyl methacrylamide, ethyl methacrylamide, propyl methacrylamide, butyl methacrylamide, t-butyl methacrylamide, cyclohexyl methacrylamide, benzyl methacrylamide, hydroxymethyl methacrylamide, methoxyethyl methacrylamide, dimethylaminoethyl methacrylamide, phenyl methacrylamide, dimethyl methacrylamide, diethyl methacrylamide, β-cyanoethyl methacrylamide, and N-(2-acetoacetoxyethyl)methacrylamide.

Acrylamides having hydroxyl groups can be used as the copolymerizable monomers, examples of which include N-hydroxymethyl-N-(1,1-dimethyl-3-oxo-butyl)acrylamide, N-methylolacrylamide, N-methylolmethacrylamide, N-ethyl-N-methylolacrylamide, N,N-dimethylolacrylamide, N-ethanolacrylamide, N-propanolacrylamide, and N-methylolacrylamide.

Examples of the itaconic acid diesters include dimethyl itaconate, diethyl itaconate, and dibutyl itaconate. Examples of maleic acid diesters include diethyl maleate, dimethyl maleate, and dibutyl maleate. Examples of fumaric acid diesters include diethyl fumarate, dimethyl fumarate, and dibutyl fumarate.

Examples of the above-mentioned vinyl ketones include methyl vinyl ketone, phenyl vinyl ketone, and methoxyethyl vinyl ketone. Examples of vinyl heterocyclic compounds include vinylpyridine, N-vinylimidazole, N-vinyloxazolidone, N-vinyltriazole, and N-vinylpyrrolidone. Examples of glycidyl esters include glycidyl acrylate and glycidyl methacrylate. Examples of unsaturated nitriles include acrylonitrile and methacrylonitrile. Examples of N-alkylmaleimides include N-ethylmaleimide and N-butylmaleimide.

Examples of the above-mentioned unsaturated carboxylic acids include acrylic acid, methacrylic acid, itaconic acid, maleic acid, fumaric acid, and crotonic acid, and further include anhydrides of fumaric acid, itaconic acid and maleic acid. Two or more of these copolymerizable monomers may also be used.

The chlorine-containing polymer referred to in the present invention has been disclosed in JP-A Nos. 53-58553, 55-43185, 57-139109, 57-139136, 60-235818, 61-108650, 62-256871, 62-280207, 63-256665, and the like.

The proportion of the chlorine-containing vinyl monomer in the chlorine-containing polymer is preferably from 50 mass % to 99 mass %, more preferably 70 mass % to 97 mass %, even more preferably 80 mass % to 95 mass %, and particularly preferably 88 mass % to 93 mass %. Keeping the proportion of chlorine-containing vinyl monomer at 50 mass % or higher yields low moisture permeability, and keeping it at 99 mass % or lower and adding other copolymerization components controls crystallinity and is preferable because it yields solubility in various solvents.

The chlorine-containing vinyl monomer is preferably vinylidene chloride.

Furthermore, the chlorine-containing polymer is preferably formed by the polymerization of vinylidene chloride and a monomer that can be copolymerized with vinylidene chloride. The monomer component that can be copolymerized with vinylidene chloride preferably includes methacrylonitrile. The proportion of methacrylonitrile with respect to the monomer component other than vinylidene chloride that can be copolymerized with vinylidene chloride is preferably 20 mass % or more, more preferably 30 mass % or more, and even more preferably 40 mass % or more.

The chlorine-containing polymer is preferably a vinylidene chloride polymer composed of 88 mass % to 93 mass % of vinylidene chloride and 7 mass % to 12 mass % of one or more kinds of monomer that can be copolymerized with vinylidene chloride and includes 40 mass % or more of methacrylonitrile. When the methacrylonitrile content is 40 mass % or more, solubility in solvents can be ensured while the increase in moisture permeability can be kept to a minimum.

Examples of the chlorine-containing polymer include Saran Resin R241C, Saran Resin F216, Saran Resin R204, Saran Latex L502, Saran Latex L529B, Saran Latex L536B, Saran Latex L544D, Saran Latex L549B, Saran Latex L551B, Saran Latex 1,557, Saran Latex L561A, Saran Latex 1,116A, Saran Latex L411A, Saran Latex 1,120, Saran Latex L123D, Saran Latex 1,106C, Saran Latex L131A, Saran Latex L111, Saran Latex 1,232A, and Saran Latex L321B (these are all made by Asahi Kasei Chemicals Corporation).

Of these, it is preferable to use a material that is soluble in organic solvents and that will maintain the low moisture permeability of the low moisture-permeable layer when the hard coat layer is laminated over the low moisture-permeable layer after the formation of the low moisture-permeable layer. Saran Resin R204, which is a vinylidene chloride polymer, is an example of a commercially available chlorine-containing polymer that satisfies these requirements.

Therefore, a preferred mode is for the low moisture-permeable layer to be formed with Saran Resin R204 as its main component. In this case, the low moisture-permeable layer preferably contains 50 mass % or more, more preferably 70 mass % or more, even more preferably 80 mass % or more, and particularly preferably 90 mass % or more of Saran Resin R204.

To satisfy these requirements, the content of the chlorine-containing polymer dissolved in 100 g of cyclohexanone at 25° C. is preferably 10 g to 40 g, more preferably 15 g to 40 g, and even more preferably 20 g to 35 g.

The thickness of the low moisture-permeable layer is preferably 0.1 μm to 10 μm, more preferably 0.3 μm to 5 μm, and even more preferably 0.5 μm to 3 μm. Low moisture permeability can be maintained and the problem of curling can be avoided by keeping the thickness of the low moisture-permeable layer within the above range.

The thickness of the low moisture-permeable layer here is measured with an interference film thickness gauge (FE-3000 manufactured by Otsuka Electronics).

The haze of the low moisture-permeable layer is preferably 5% or less, more preferably 3% or less, and even more preferably 1% or less. The ratio between surface haze and internal haze may be set as desired, but it is particularly preferable for the surface haze to be 1% or less.

### <<Hard Coat Layer>>

The protective film of the present invention preferably has a hard coat layer in order to impart physical strength.

From the standpoint of imparting the film with enough surface hardness while still making it easy to be processed, the thickness of the hard coat layer is preferably about 10 μm to 40 μm, more preferably 12 μm to 35 μm, and even more preferably 15 μm to 30 μm.

The strength of the hard coat layer, as measured by pencil hardness test, is preferably 4 H or more, and more preferably 5 H or more.

The pencil hardness can be found as the value at which no scratching is seen at a load of 4.9 N, using a test pencil as set forth in JIS S 6006, according to the pencil hardness evaluation method set forth in JIS K 5400.

Factors involved in raising the pencil hardness include the thickness of the hard coat layer, the binder used, the filler used, and the curing conditions, and these will be described below.

The hard coat layer is preferably formed by subjecting a curable composition to a crosslinking reaction or a polymerization reaction. For instance, it is formed by coating a transparent substrate film with a coating composition containing a curable polyfunctional monomer or polyfunctional oligomer, and subjecting the polyfunctional monomer or polyfunctional oligomer to a crosslinking reaction or a polymerization reaction.

The functional groups of the curable polyfunctional monomer or polyfunctional oligomer are preferably polymerizable, and polymerizable functional groups are particularly preferable. Examples of polymerizable functional groups include unsaturated polymerizable functional groups (polymerizable unsaturated groups) such as a (meth)acryloyl group, vinyl group, styryl group and allyl group. Of these, a (meth)acryloyl group is preferable.

A crosslinkable functional group may be introduced into the binder instead of or in addition to the polymerizable unsaturated group. Examples of crosslinkable functional groups include an isocyanate group, epoxy group, aziridine group, oxazoline group, aldehyde group, carbonyl group, hydrazine group, carboxyl group, methylol group, and active methylene group. Vinylsulfonic acid, acid anhydrides, cyanoacrylate derivatives, melamine, etherified methylol, esters, urethane, and metal alkoxides such as tetramethoxysilane can also be utilized as monomers having a crosslinked structure. A functional group that exhibits crosslinking as the result of a decomposition reaction, such as a block isocyanate group, may also be used.

Specifically, the crosslinkable functional group need not exhibit a reaction right away, and may instead exhibit reactivity as the result of being decomposed. A crosslinked structure can be formed by applying a binder having these crosslinkable functional groups and then heating.

Moreover, the curable composition in the invention may contain fine particles. When fine particles are contained, the amount of curing shrinkage of the hard coat layer can be reduced, so curing shrinkage of the hard coat layer does not produce as much strain in the low moisture-permeable layer on which this hard coat layer has been laminated, the favorable result being that there is less increase in moisture permeability, or curling can be reduced. Also, the curable composition may contain fine particles that impart an internal scattering property.

The amount of the fine particles contained in the binder is preferably 5 mass % to 40 mass %, more preferably 15 mass % to 40 mass %, and even more preferably 20 mass % to 35 mass %.

Inorganic particles or a monomer having a high refractive index can be added, either singly or together, to the binder of the hard coat layer for the purpose of controlling the refractive index of the hard coat layer. In addition to controlling the refractive index, inorganic particles also have the effect of reducing curing shrinkage caused by a crosslinking reaction.

In the present invention, the polymer produced by polymerization of the polyfunctional monomer and/or high-refractive index monomer, etc., after the formation of the hard coat layer is called a binder, and the binder preferably includes dispersed inorganic particles.

The haze of the hard coat layer varies with the function imparted to the protective film for polarizing plate. When image sharpness is to be maintained and the reflectivity of the surface lowered, so that no optical scattering function is imparted at the surface or in the interior of the hard coat layer, the lower the haze value the better, and more specifically, 10% or less is preferable, 5% or less is more preferable, and 2% or less is even more preferable.

Meanwhile, when an anti-glare function is to be imparted by surface scattering on the hard coat layer in addition to the function of imparting physical strength, the surface haze is preferably 1% to 15%, and more preferably 2% to 10%.

Moreover, when a function is to be imparted whereby the liquid crystal panel pattern or color unevenness, brightness unevenness, glare, etc., is made less noticeable by internal scattering in the hard coat layer, or the view angle is widened by scattering, then the internal haze value (obtained by subtracting the surface haze value from the total haze value) is preferably 10% to 90%, more preferably 15% to 70%, and even more preferably 20% to 50%.

Thus, the surface haze and internal haze of the protective film of the present invention can be set freely according to the intended use.

As to surface asperities of the hard coat layer, to obtain a clear surface for the purpose of maintaining image sharpness, of the characteristics that indicate surface roughness, for example, the center line average roughness (Ra) is preferably 0.10 μm or less. Ra is more preferably 0.09 μm or less, and even more preferably 0.08 μm or less.

In the protective film of the present invention, the surface asperities of the hard coat layer is dominant over the surface asperities of the protective film, and the center line average roughness of the protective film for polarizing plate can be adjusted to within the above range by adjusting the center line average roughness of the hard coat layer.

For the purpose of maintaining the sharpness of the image, it is preferable to adjust the transmitted image sharpness in addition to adjust the surface asperities. The transmitted image sharpness of a clear protective film for polarizing plate is preferably 60% or more. The transmitted image sharpness is generally an index of the blurring of an image that shows through a film, and the larger its value is, the better the sharpness of the image seen through the film is. The transparent image sharpness is preferably 70% or more, and more preferably 80% or more.

### [Anti-Glare Hard Coat Layer]

When the protective film for polarizing plate of the present invention is used on the surface of a liquid crystal display device, the reflected image of surrounding objects can sometimes be seen on the surface, which lowers the visibility of the displayed image. In order to prevent this, it is preferable to texture the surface of the hard coat layer and impart performance whereby light is scattered on the surface (anti-glare property).

Moreover, there are cases when the low moisture-permeable layer has a higher refractive index than the transparent substrate film, and the difference in refractive index between the low moisture-permeable layer and the transparent substrate film produces interference fringe. To prevent the interference fringe from adversely affecting visibility, it is preferable to impart an optical scattering property.

Methods for forming an anti-glare property are given in JP-A No. 6-16851, in which a mat-shaped film having microscopic asperities on its surface is formed by lamination; in JP-A No. 2000-206317, which makes use of curing shrinkage in an ionizing radiation-curing resin brought about by a difference in the ionizing radiation dosage; in JP-A No. 2000-338310, in which the mass ratio of good solvent to translucent resin is reduced by drying, thereby gelling and solidifying translucent fine particles and the translucent resin, and forming asperities on the coating film surface; in JP-A No. 2000-275404, in which surface asperities is imparted by pressure from the outside; in JP-A No. 2005-195819, in which surface asperities is formed by taking advantage of the fact that phase separation occurs in the course of evaporating a solvent from a mixed solution of a plurality of polymers; and the like, and these known methods can be employed for the above purpose.

In a preferred configuration of an anti-glare layer that can be used in the present invention, a binder which can impart hard coat properties, fine particles for imparting an anti-glare property, and a solvent are contained as essential components, and asperities is formed on the surface by protrusions formed by aggregates of a plurality of particles or by protrusions of the fine particles themselves.

The anti-glare layer preferably provides both anti-glare and hard coat properties. The binder and fine particles will now be described in detail.

### [Binder]

The protective film of the present invention can be formed by subjecting a curable compound to a crosslinking reaction or a polymerization reaction. Specifically, it can be formed by coating a transparent substrate film with a coating composition containing a curable polyfunctional monomer or polyfunctional oligomer as a binder, and subjecting the polyfunctional monomer or polyfunctional oligomer to a crosslinking reaction or a polymerization reaction.

Examples of polymerizable functional groups include unsaturated polymerizable functional groups such as a (meth)acryloyl group, vinyl group, styryl group and allyl group. Of these, a (meth)acryloyl group is preferable.

Specific examples of polyfunctional monomers having polymerizable groups include (meth)acrylic diesters of an alkylene glycol such as neopentyl glycol acrylate, 1,6-hexanediol(meth)acrylate and propylene glycol di(meth)acrylate; (meth)acrylic diesters of a polyoxyalkylene glycol such as triethylene glycol di(meth)acrylate, dipropylene glycol di(meth)acrylate, polyethylene glycol di(meth)acrylate and polypropylene glycol di(meth)acrylate; (meth)acrylic diesters of a polyhydric alcohol such as pentaerythritol di(meth)acrylate; and (meth)acrylic diesters of an ethylene oxide or propylene oxide adduct such as 2,2-bis{4-(acryloxy diethoxy)phenyl}propane, 2,2-bis{4-(acryloxy polypropoxy)phenyl}propane.

Furthermore, epoxy(meth)acrylates, urethane(meth)acrylates, and polyester(meth)acrylates can also be preferably used as photopolymerizable polyfunctional monomers.

Of these, esters of a polyhydric alcohol and (meth)acrylic acid are preferable, and polyfunctional monomers having three or more (meth)acryloyl groups per molecule are more preferable.

Specific examples include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, tripentaerythritol triacrylate, and tripentaerythritol hexatriacrylate.

In this specification, the terms “(meth)acrylate,” “(meth)acrylic acid,” and “(meth)acryloyl” mean “acrylate or methacrylate,” “acrylic acid or methacrylic acid,” and “acryloyl or methacryloyl,” respectively.

Two or more types of polyfunctional monomers may be used together.

The polymerization of these monomers having ethylenic unsaturated groups can be accomplished by heating or irradiation with ionizing radiation in the presence of a thermal radical initiator or a photo radical initiator.

It is preferable to use a photopolymerization initiator for the polymerization reaction of the polymerizable polyfunctional monomer. Photo radical polymerization initiators and photo cationic polymerization initiators are preferable as the photopolymerization initiator, and photo cationic polymerization initiators are particularly preferable.

### <Photopolymerization Initiator>

Examples of the photo radical polymerization initiators include acetophenones, benzoins, benzophenones, phosphine oxides, ketals, anthraquinones, thioxanthones, azo compounds, peroxides (JP-A No. 2001-139663, etc.), 2,3-dialkyldione compounds, disulfide compounds, fluoroamine compounds, aromatic sulfoniums, lophine dimers, onium salts, borate salts, active esters, active halogens, inorganic complexes, and coumarins.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone, and 4-t-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesilfonic acid ester, benzoin methyl ether, benzoin ethyl ether, and benzoin isopropyl ether.

Examples of benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), and 3,3′,4,4′-tetra(t-butyl peroxycarbonyl)benzophenone.

Examples of the borate salts include the organic borate salts mentioned in Japanese Patent (JP-B) No. 2764769, JP-A No. 2002-116539, and Kunz and Martin, “Rad Tech '98, Proceeding April, pp. 19 to 22 (1998), Chicago.” For example, there are the compounds mentioned in paragraphs [0022] to [0027] in the specification of the above-mentioned JP-A No. 2002-116539.

Moreover, specific examples of other organoboron compounds include organoboron transition metal-coordinated complexes as described in JP-A Nos. 6-348011, 7-128785, 7-140589, 7-306527, and 7-292014. Specific examples thereof include ion complexes with a cationic dye.

Examples of the phosphine oxides include 2,4,6-trimethylbenzoyl diphenylphosphine oxide.

Examples of the active esters include 1,2-octanedione, 1-[4-(phenylthio)-2-(O-benzoyloxime)], sulfonic acid esters, and cyclic active ester compounds.

More specifically, compounds 1 to 21 listed in the examples of JP-A No. 2000-80068 are particularly preferable.

Examples of onium salts include aromatic diazonium salts, aromatic iodonium salts, and aromatic sulfonium salts.

Specific examples of the active halogens include the compounds mentioned in Wakabayashi et al., Bull. Chem. Soc. Japan, Vol. 42, p. 2924 (1969); U.S. Pat. No. 3,905,815; JP-A No. 5-27830; and M. P. Hutt, Journal of Heterocyclic Chemistry, Vol. 1 (No. 3), 1970, and especially an s-triazine compounds which is an oxazole compound having a trihalomethyl group substituted thereon.

More preferable examples include s-triazine derivatives in which at least one mono-, di-, or trihalogen-substituted methyl group is bonded to an s-triazine ring.

These initiators may be used singly or as mixtures.

Preferable examples of commercially available photo radical polymerization initiators include Kayacure manufactured by Nippon Kayaku (such as DETX-S, BP-100, BDMK, CTX, BMS, 2-EAQ, ABQ, CPTX, EPD, ITX, QTX, BTC, and MCA), Irgacure made by Ciba Specialty Chemicals (such as 651, 184, 500, 819, 907, 369, 1173, 1870, 2959, 4265, and 4263), Esacure made by Sartomer (such as KIP100F, KB1, EB3, BP, X33, KT046, KT37, KIP150, and TZT), and combinations of these.

The photopolymerization initiator is preferably used in an amount of 0.1 parts by mass to 15 parts by mass, and more preferably 1 part by mass to 10 parts by mass based on 100 parts by mass of polyfunctional monomer.

### <Photosensitizer>

A photosensitizer may be used in addition to the photopolymerization initiator. Specific examples of the photosensitizer include n-butylamine, triethylamine, tri-n-butylphosphine, Michler's ketone, and thioxanthone.

Furthermore, one or more kinds of auxiliary agent such as an azide compound, thiourea compound, or mercapto compound may be combined and used.

Examples of commercially available photosensitizers include Kayacure made by Nippon Kayaku (such as DMBI and EPA).

### <Thermal Radical Initiator>

Examples of thermal radical initiators which can be used include organic and inorganic peroxides, and organic azo and diazo compounds.

More specifically, examples of organic peroxides include benzoyl peroxide, halogen benzoyl peroxides, lauroyl peroxide, acetyl peroxide, dibutyl peroxide, cumene hydroperoxide, and butyl hydroperoxide; examples of inorganic peroxides include hydrogen peroxide, ammonium persulfate, and potassium persulfate; examples of azo compounds include 2,2′-azobis(isobutyronitrile), 2,2′-azobis(propionitrile), and 1,1′-azobis(cyclohexanecarbonitrile); and examples of diazo compounds include diazoaminobenzene and p-nitrobenzene diazonium.

### [Fine Particles]

The fine particles may be either organic particles or inorganic particles. Organic particles are preferred as the fine particles, and ones having high transparency and a refractive index difference from that of the binder of 0.01 to 0.3 are particularly preferable.

Examples of the organic particles include polymethyl methacrylate particles (refractive index: 1.49), crosslinked poly(acrylic-styrene) copolymer particles (refractive index: 1.54), melamine resin particles (refractive index: 1.57), polycarbonate particles (refractive index: 1.57), polystyrene particles (refractive index: 1.60), crosslinked polystyrene particles (refractive index: 1.61), polyvinyl chloride particles (refractive index: 1.60), and benzoguanamine-melamine formaldehyde particles (refractive index: 1.68).

Examples of inorganic particles include silica particles (refractive index: 1.44), alumina particles (refractive index: 1.63), zirconia particles, titania particles, and hollow or porous inorganic particles.

Of these fine particles, crosslinked polystyrene particles, crosslinked poly((meth)acrylate) particles, and crosslinked poly(acryl-styrene) particles are preferably used. The internal haze, surface haze, and center line average roughness of the present invention can be attained by adjusting the refractive index of the binder according to the refractive index of the fine particles selected from among these particles.

The refractive index of the binder (translucent resin) and the translucent particle is preferably from 1.45 to 1.70, and more preferably from 1.48 to 1.65. The kinds and proportions of the binder and the fine particles may be suitably selected to adjust the refractive index to be within the above range. How to make these selections can be easily ascertained by experimentation in advance.

Here, the refractive index of the binder can be quantitatively evaluated by, for example, directly measuring with an Abbe refractometer, or measuring the spectral reflection spectrum or spectral ellipsometry. The refractive index of the fine particles is measured by dispersing an equivalent amount of the fine particles in a solvent having a refractive index varied by varying the mix ratio of two kinds of solvents having different refractive indexes, measuring the turbidity, and measuring the refractive index of the solvent at the point of minimum turbidity with an Abbe refractometer.

In the case of the above fine particles, since they tend to settle in the binder, an inorganic filler such as silica may be added to prevent settling. The larger is the amount in which the inorganic filler is added, the more effective it will be at preventing settling of the fine particles, but it will also have more of an adverse effect on the transparency of the coating film. Therefore, an inorganic filler having a particle diameter of 0.5 μm or less is preferably contained in an amount of less than about 0.1 mass % in the binder so that the transparency of the coating film is not impaired.

When the hard coat layer is an anti-glare layer, the fine particles used to impart the anti-glare property are preferably particles that are larger in size.

When the particles are too small, they are embedded inside the anti-glare layer, making it difficult to produce asperities on the surface. Also, use of particles which are larger in size allows the light scattering angle to be narrowed, and character blurring to be prevented.

More specifically, the fine particles preferably have an average particle diameter of from 4 μm to 15 μm, more preferably 5 μm to 12 μm, and even more preferably 6 μm to 10 μm.

It is also preferable for the particle diameter to be 30% to 75% of the thickness of the hard coat layer.

Two or more kinds of fine particles having different particle diameters may also be used together. The larger particles impart the anti-glare property, while the smaller particles reduce roughness on the surface.

The fine particles are preferably contained in an amount of 3 mass % to 30 mass % in the total solids of a layer in which fine particles are added, and more preferably are contained in an amount of 5 mass % to 20 mass % in total solids of the layer. When the amount is less than 3 mass %, the addition will not have the desired effect, and when 30 mass % is exceeded, this may cause problems such as image blurring, surface cloudiness, and glare.

Also, the fine particles preferably have a density of from 10 mg/m² to 1,000 mg/m², and more preferably from 100 mg/m² to 700 mg/m².

### <Preparation and Classification of Fine Particles>

Examples of the method for producing the fine particles include suspension polymerization, emulsion polymerization, soap-free emulsion polymerization, dispersion polymerization, and seed polymerization, but the fine particles may be produced by any method.

For more about these production methods, the methods can be referred to, for example, Experimental Methods for Polymer Synthesis [Koubunshi Gousei no Jikkenhou] (written by Takayuki Otsu and Masayoshi Kinoshita, Kagaku Dojin Publishing Company, INC.), p. 130 and pp. 146 to 147; Synthetic Polymers [Gousei Koubanshi], Vol. 1, pp. 246 to 290; and ibid., Vol. 3, pp. 1 to 108, as well as to the methods described in JP-B Nos. 2,543,503, 3,508,304, 2,746,275, 3,521,560, and 3,580,320, and JP-A Nos. 10-1561, 7-2908, 5-297506, and 2002-145919.

As to the particle size distribution of the fine particles, monodisperse particles are preferable in view of controlling the haze value and diffusibility and the uniformity of coated surface properties. For instance, when particles having a size that is 20% or more larger than the average particle diameter are defined as being coarse particles, the proportion of these coarse particles is preferably 1% or less, more preferably 0.1% or less, and even more preferably 0.01% or less.

Classification after the preparation or synthesis reaction is another effective way to obtain particles having a size distribution described above, and particles having a preferable particle size distribution can be obtained by increasing the number of times of classification or strengthening the degree of classification.

The classification is preferably accomplished by air classification, centrifugal classification, sedimentation classification, filtration classification, electrostatic classification, or the like.

Also, two or more kinds of matte particles having different particle sizes may be used together. It is possible to impart an anti-glare property with matte particles having a larger particle size and to impart other optical characteristics with matte particles having a smaller particle size. For example, a defect in display image quality that is called “glare” may occur when an anti-glare, antireflection film is applied to a high definition display of 133 ppi or more.

The glare is caused by that pixels enlarged or shrunk by asperities present on the surface of the anti-glare, antireflection film, and uniformity of luminance is lost. The glare can be greatly mitigated by concurrently using matte particles having a smaller particle size than the matte particles which impart the anti-glare property and having a different refractive index from that of the binder.

The particle size distribution of the matte particles is measured by Coulter counter method, and the measured distribution is converted into a particle count distribution.

### [Solvent of Hard Coat Layer]

It is frequently the case that the hard coat layer is applied as a wet coating over the low moisture-permeable layer, so the solvent used in the coating composition is a particularly important factor. The requirements of this solvent are that it thoroughly dissolves the above-mentioned translucent resin and various other solutes, that it not dissolve the above-mentioned translucent fine particles, and that it produce little coating unevenness or drying unevenness in the coating and drying steps.

Other preferable characteristics are that the solubility of the underlying layer is not too high (this is necessary to prevent problems such as whitening or loss of flatness), that it conversely dissolves or swells the coat layer as little as possible (this is necessary for good adhesion), and the like.

A solvent may be used singly, but it is particularly preferable to use two or more kinds of solvents and adjust the coat layer solubility and swelling, solubility of the material, drying characteristics, particle agglomeration, and the like. Moreover, adhesion to the coat layer can be improved without adversely affecting other performance aspects or conditions by adding a small amount of a solvent having high swelling ability to the main solvent which does not swell the coat layer very much.

Specific examples of solvents which can be preferably used include various ketones (such as methyl ethyl ketone, acetone, methyl isobutyl ketone, and cyclohexanone), various esters (such as methyl acetate and ethyl acetate), and various cellosolves (such as ethyl cellosolve, butyl cellosolve, and propylene glycol monomethyl ether).

Additionally, various alcohols (such as propylene glycol, ethylene glycol, ethanol, methanol, isopropyl alcohol, 1-butanol, and 2-butanol), toluene, and the like can be preferably used.

### [High Refractive Index Layer (Middle Refractive Index Layer)]

On the protective film of the present invention, the antireflective property can be further enhanced by providing a high refractive index layer and a middle refractive index layer over the hard coat layer, and utilizing optical interference along with the low refractive index layer (described below).

In the following description, the high refractive index layer and the middle refractive index layer may sometimes be referred to collectively as a high refractive index layer. In the present invention, the terms “high,” “middle,” and “low” as used in the high refractive index layer, middle refractive index layer, and low refractive index layer express the relative magnitude in the refractive indexes of the layers. Furthermore, so far as the relation of those layers to the transparent substrate is concerned, it is preferable that the refractive index of the transparent substrate film is larger than that of the low refractive index layer and the refractive index of the transparent substrate film is smaller than that of the high refractive index layer.

In this specification, the high refractive index layer, the middle refractive index layer, and the low refractive index layer may sometimes be referred to collectively as an anti-reflection layer.

To form the low refractive index layer over the high refractive index layer and thereby produce the antireflection film, the high refractive index layer preferably has a refractive index of from 1.55 to 2.40, more preferably from 1.60 to 2.20, even more preferably from 1.65 to 2.10, and most preferably from 1.80 to 2.00.

When the transparent substrate film is coated with a coat layer, a hard coat layer, a middle refractive index layer, a high refractive index layer, and a low refractive index layer in that order to produce an antireflection film, the high refractive index layer preferably has a refractive index of from 1.65 to 2.40, and more preferably from 1.70 to 2.20. The refractive index of the middle refractive index layer is adjusted so as to have a value between the refractive index of the low refractive index layer and the refractive index of the high refractive index layer. The refractive index of the middle refractive index layer is preferably from 1.55 to 1.80.

Specific examples of the inorganic particles used in the high refractive index layer and the middle refractive index layer include TiO₂, ZrO₂, Al₂O₃, In₂O₃, ZnO, SnO₂, Sb₂O₃, ITO, and SiO₂. Of these, TiO₂ and ZrO₂ are particularly preferable in terms of achieving a high refractive index.

The surface of the above-mentioned inorganic filler is preferably subjected to a silane coupling treatment or a titanium coupling treatment, and a surface treatment agent having functional groups capable of reacting with binder species on the filler surface can be preferably used.

The amount in which the inorganic particles are contained in the high refractive index layer is preferably from 10 mass % to 90 mass %, more preferably 15 mass % to 80 mass %, and even more preferably 15 mass % to 75 mass %, based on the mass of the high refractive index layer. Two or more kinds of inorganic particles may be used together in the high refractive index layer.

If the low refractive index layer is disposed over the high refractive index layer, the refractive index of the high refractive index layer is preferably higher than the refractive index of the transparent substrate film.

A binder which is obtained by a crosslinking or polymerization reaction, such as an ionizing radiation-curing compound containing an aromatic ring, an ionizing radiation-curing compound containing a halogen atom other than fluorine (such as bromine, iodine, or chlorine), or an ionizing radiation-curing compound containing an atom such as sulfur, nitrogen, or phosphorus, can be preferably used for the high refractive index layer.

The thickness of the high refractive index layer can be suitably designed depending on the application. When the high refractive index layer is used as an optical interference layer described below, thickness of the high refractive index layer is preferably 30 nm to 200 nm, more preferably 50 nm to 170 nm, and even more preferably 60 nm to 150 nm.

When the high refractive index layer does not contain any particles that impart an antiglare function, the haze of the high refractive index layer is preferably as low as possible. For example, the haze is preferably 5% or less, more preferably 3% or less, and even more preferably 1% or less. The high refractive index layer is preferably formed over the transparent substrate film via another layer.

When the protective film for polarizing plate of the present invention is used over the surface of a liquid crystal display device, forming a low refractive index layer over the surface of the hard coat layer is a favorable way to prevent ghost. A low refractive index layer which can be preferably used in the present invention will now be described.

### [Low Refractive Index Layer]

The low refractive index layer is preferably formed by coating with a thermosetting and/or photocurable composition whose main component is a fluorine-containing compound which contains 35 mass % to 80 mass % of fluorine atoms and which contains crosslinkable or polymerizable functional groups.

The low refractive index layer in the above-mentioned anti-glare, antireflection film is preferably 1.45 or less, more preferably 1.30 to 1.40, and even more preferably 1.33 to 1.37.

The low refractive index layer preferably satisfies the following Formula 3 in order to reduce the refractive index.

¼×0.7×λ<n1×d1<¼×1.3×λ Formula 3

wherein n1 is the refractive index of the low refractive index layer, and d1 is the thickness (nm) of the low refractive index layer. Also, λ is a value measured in a wavelength range of from 500 nm to 550 nm.

Formula 3 represents that an optical thickness found by the product of the refractive index of the low refractive index layer and the thickness thereof is close to the quarter-wavelength from 500 nm to 550 nm, which is the optical wavelength range of highest luminosity factor.

The thickness of the low refractive index layer is preferably 70 nm to 120 nm as a value found by Formula 3.

The low refractive index layer is, for example, a cured film formed by coating with a curable composition whose main component is a fluorine-containing compound, and then drying and curing this coating.

The curable composition used in the formation of the low refractive index layer preferably contains two or more of (A) a fluorine-containing compound, (B) inorganic particles, and (C) an organosilane compound, and it is particularly preferable for it to contain all three.

A fluorine-containing polymer having a low refractive index, or a fluorine-containing sol-gel material or the like, is preferably used as the fluorine-containing compound.

The fluorine-containing polymer or fluorine-containing sol-gel is preferably a material which is crosslinked by heat or ionizing radiation and in which the surface of the formed low refractive index layer has a dynamic coefficient of friction of from 0.03 to 0.30 and a contact angle with respect to water of from 85° to 120°. The material which forms the low refractive index layer will now be described.

### <Fluorine-Containing Polymer for Low Refractive Index Layer>

The fluorine-containing polymer is such that the dynamic coefficient of friction of the film after curing is from 0.03 to 0.20, the contact angle with respect to water is from 90° to 120°, and the sliding angle of pure water is 70° or less. This is preferably a polymer which is crosslinked by heat or ionizing radiation, because productivity will be higher when a film roll is coated and cured during web conveyance.

Furthermore, in the case where the anti-glare film or anti-glare antireflection film is attached to a liquid crystal display device, since seals or memos after being stuck can be peeled off more easily as the peel force with a commercially available adhesive tape is lower, the peel force is preferably 500 gf (4.9 N) or less, more preferably 300 gf (2.9 N) or less, and even more preferably 100 gf (0.98 N) or less. Also, the surface becomes harder to scratch as the surface hardness as measured by a microhardness meter becomes higher, and the surface hardness is therefore preferably 0.3 GPa or more, and more preferably 0.5 GPa or more.

The fluorine-containing polymer used in the low refractive index layer is preferably one which contains 35 mass % to 80 mass % fluorine atoms and contains crosslinkable or polymerizable functional groups. Examples thereof include hydrolysates and dehydration condensates of silane compounds containing perfluoroalkyl groups (such as (heptadecafluoro-1,1,2,2-tetrahydrodecyl)triethoxysilane), and fluorine-containing polymers whose structural units are fluorine-containing monomer units and crosslinkable units. In the case of a fluorine-containing copolymer, the main chain is preferably composed only of carbon atoms. That is, there are preferably no oxygen atoms, nitrogen atoms, or the like in the main chain skeleton.

Specific examples of the fluorine-containing monomer unit include fluoroolefins (such as fluoroethylene, vinylidene fluoride, tetrafluoroethylene, perfluorooctylethylene, hexafluoropropylene, and perfluoro-2,2-dimethyl-1,3-dioxole), partially or completely fluorinated alkyl ester derivatives of (meth)acrylic acid (such as Viscoat 6FM (manufactured by Osaka Organic Chemical Industry) and M-2020 (manufactured by Daikin Industries)), and completely or partially fluorinated vinyl ethers. Of these, perfluoroolefins are preferred, and hexafluoropropylene are more preferable from the standpoints of refractive index, solubility, transparency, and availability.

Examples of the crosslinkable units include structural units obtained by the polymerization of a monomer already having in its molecule a self-crosslinkable functional group, such as glycidyl(meth)acrylate or glycidyl vinyl ether; and structural units obtained by introducing a crosslinkable group such as (meth)acryloyl group by polymer reaction into a structural unit obtained by the polymerization of a monomer having a carboxyl group, hydroxyl group, amino group, sulfo group, or the like (such as (meth)acrylic acid, methylol(meth)acrylate, hydroxyalkyl(meth)acrylate, allyl acrylate, hydroxyethyl vinyl ether, hydroxybutyl vinyl ether, maleic acid, or crotonic acid) (for example, this group can be introduced by causing acrylic acid chloride to act on a hydroxy group).

In addition to the above-mentioned fluorine-containing monomer units and crosslinkable units, other polymerization units can also be introduced as needed by copolymerizing a monomer containing no fluorine atoms, in order to improve solubility in a solvent, the transparency of the film, and the like.

There are no particular restrictions on the other monomer units that can be used, and examples include olefins (such as ethylene, propylene, isoprene, vinyl chloride, and vinylidene chloride), acrylic acid esters (such as methyl acrylate, ethyl acrylate, and 2-ethylhexyl acrylate), methacrylic acid esters (such as methyl methacrylate, ethyl methacrylate, butyl methacrylate, and ethylene glycol dimethacrylate), styrene derivatives (such as styrene, divinylbenzene, vinyltoluene, and a-methylstyrene), vinyl ethers (such as methyl vinyl ether, ethyl vinyl ether, and cyclohexyl vinyl ether), vinyl esters (such as vinyl acetate, vinyl propionate, and vinyl cinnamate), acrylamides (such as N-tert-butylacrylamide and N-cyclohexylacrylamide), methacrylamides, and acrylonitrile derivatives.

The fluorine-containing polymer may be used in combination with a curing agent as described in JP-A Nos.10-25388 and 10-147739, as needed.

The fluorine-containing polymer that is particularly useful in the present invention is a random copolymer of a perfluoroolefin and a vinyl ether or a vinyl ester.

It is particularly preferable for this polymer to have a group which is crosslinkable by itself (for example, radical polymerizable groups such as a (meth)acryloyl group, and ring cleavage polymerizable groups such as an epoxy group, and an oxetanyl group).

These polymerization units containing crosslinkable groups preferably account for 5 mol % to 70 mol %, and more preferably 30 mol % to 60 mol %, of the total polymerization units of a polymer.

A preferred configuration of the fluorine-containing polymer used for the low refractive index layer is a copolymer expressed by the following General Formula 2.

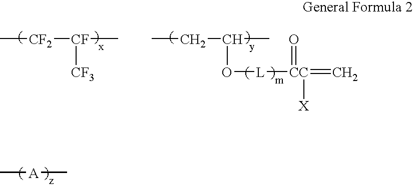

### <Inorganic Fine Particles for Low Refractive Index Layer>

The amount in which the inorganic fine particles are added is preferably from 1 mg/m² to 100 mg/m², more preferably from 5 mg/m² to 80 mg/m², and even more preferably from 10 mg/M² to 60 mg/M². When the amount is too small, there may be less improvement in scratch resistance, but when the amount is too large, microscopic asperities may be formed on the surface of the low refractive index layer, which can adversely affect the appearance (such as black streaks) and the integrated reflectivity, so it is preferable for the amount to be within the above range.

Because inorganic fine particles are contained in the low refractive index layer, it is desirable for the inorganic fine particles to have a low refractive index. Examples of such fine particles include magnesium fluoride and silicon oxide (silica). In terms of the refractive index, dispersion stability, and cost, silica fine particles are particularly preferable.

The average particle diameter of the inorganic fine particles is, for example, 10% to 100%, preferably 30% to 100%, more preferably 35% to 80%, and even more preferably 40% to 60%, of the thickness of the low refractive index layer. That is, when the thickness of the low refractive index layer is 100 nm, then the particle diameter of the silica fine particle is preferably 30 nm to 100 nm, more preferably 35 nm to 80 nm, and even more preferably 40 nm to 60 nm.

When the inorganic fine particles are too small, they will have less effect of improving scratch resistance, but when they are too large, microscopic asperities may be formed on the surface of the low refractive index layer, which can adversely affect the appearance (such as black streaks) and the integrated reflectivity, so it is preferable for the amount to be within the above range.

The inorganic fine particles may be either crystalline or amorphous, and may be monodisperse particles or agglomerated particles, as long as the particle size requirement is satisfied. Though the optimal shape is spherical, no problems are encountered if the particles are amorphous.

The average size of the inorganic fine particles refers to the average particle diameter as measured by Coulter counter.

To further minimize the increase in the refractive index of the low refractive index layer, the inorganic fine particles preferably have a hollow structure, and the refractive index of the inorganic fine particles is preferably from 1.17 to 1.40, more preferably from 1.17 to 1.35, and even more preferably from 1.17 to 1.30. The refractive index here expresses the refractive index of the particles on the whole, and does not express the refractive index of just the inorganic material of the outer shell when the inorganic fine particles have a hollow structure. Here, when “a” is a radius of a space within a particle, and “b” is a radius of a particle outer shell, then a percentage of void x is expressed by the following Formula 4.

x=(4πa³/3)/(4πb³/3)×100 Formula 4

The percentage of void x is preferably from 10% to 60%, more preferably from 20% to 60%, and even more preferably from 30% to 60%.

When an attempt is made to give the hollow inorganic fine particles a lower refractive index and a higher percentage of void, the outer shell will be thinner and the strength of the particle will be lower, so particles having a low refractive index of less than 1.17 are not feasible from the standpoint of scratch resistance.

The refractive index of the inorganic fine particles can be measured with an Abbe refractometer (manufactured by Atago Co., Ltd.).

Moreover, at least one kind of inorganic fine particles having an average particle diameter of less than 25% of the thickness of the low refractive index layer (hereinafter referred to as “small-sized inorganic fine particles”) may be used together with the inorganic fine particles having a particle diameter within the preferred range given above (hereinafter referred to as “large-sized inorganic fine particles”).

Since the small-sized inorganic fine particles can be present in the gaps between the large-sized inorganic fine particles, they can contribute as an agent for retaining the large-sized inorganic fine particles.

If the low refractive index layer is 100 nm thick, the average size of the small-sized inorganic fine particles is preferably 1 nm to 20 nm, more preferably 5 nm to 15 nm, and even more preferably 10 nm to 15 nm. The use of such inorganic fine particles is preferable from the standpoints of raw material cost and the effect of the retaining agent.

As discussed above, the inorganic fine particles having an average particle diameter from 30% to 100% of the thickness of the low refractive index layer, having a hollow structure, and having the refractive index from 1.17 to 1.40 is particularly preferably used.

To achieve dispersion stability in the dispersion or coating liquid, or to improve affinity and bondability with the binder component, the inorganic fine particles may undergo a physical surface treatment such as a plasma discharge treatment or a corona discharge treatment, or a chemical surface treatment with a surfactant, a coupling agent, or the like. A coupling agent is particularly preferably used.

An alkoxy metal compound (such as a titanium coupling agent or a silane coupling agent) is preferably used as the coupling agent. A silane coupling treatment is especially effective.

The coupling agent is used as a surface treatment agent for the inorganic fine particles of the low refractive index layer to perform a surface treatment prior to the preparation of the coating liquid for this layer. However, the coupling agent is preferably further added as an additive to the low refractive index layer during preparation of the layer coating liquid.

It is preferred that the inorganic fine particles be previously dispersed in the medium prior to the surface treatment in order to reduce the burden of surface treatment.

Next, the organosilane compound (C) will be described.

### <Organosilane Compound for Low Refractive Index Layer>

It is preferable from the standpoint of scratch resistance, and particularly from the standpoint of achieving both anti-reflection ability and scratch resistance, that one or more compounds selected from among an organosilane compound, a hydrolysate of the organosilane and a partial condensate of a hydrolysate of the organosilane (the obtained reaction solution will hereinafter sometimes be referred to as a “sol component”) be contained in the curable composition.

These compounds function as a binder of the low refractive index layer by forming a cured material when the curable composition is applied and then condensed in the drying and heating steps. Moreover, in the present invention, since the above-mentioned fluorine-containing polymer is used as a fluorine-containing compound, a binder having a three-dimensional structure is formed by irradiation with active light rays.

The organosilane compound is preferably one expressed by the following General Formula 4.

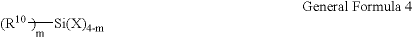

wherein R¹⁰ is a substituted or unsubstituted alkyl group or a substituted or unsubstituted aryl group. Examples of alkyl groups include methyl, ethyl, propyl, isopropyl, hexyl, decyl, and hexadecyl.

The alkyl group preferably has from 1 to 30 carbon atoms, more preferably from 1 to 16 carbon atoms, and even more preferably from 1 to 6 carbon atoms. Examples of aryl groups include phenyl and naphthyl, of which a phenyl group is preferable.

X is a hydroxyl group or a hydrolyzable group, examples of which include an alkoxy group (preferably an alkoxy group having 1 to 5 carbon atoms, such as a methoxy group or an ethoxy group), a halogen atom (such as Cl, Br, or I), and R²COO (where R² is preferably a hydrogen atom or an alkyl group having 1 to 5 carbon atoms, examples of which include CH₃COO and C₂H₅COO). Of these, an alkoxy group is preferable, and a methoxy group and an ethoxy group are particularly preferable.

“m” is an integer from 1 to 3, preferably 1 or 2, and more preferably 1.

When a plurality of R¹⁰s or Xs are present, the plurality of R¹⁰s or Xs may be the same or different.

There are no particular restrictions on the substituent contained in R¹⁰. Examples thereof include a halogen atom (such as fluorine, chlorine, and bromine), a hydroxyl group, a mercapto group, a carboxyl group, an epoxy group, an alkyl group (such as methyl, ethyl, i-propyl, propyl, and t-butyl), an aryl group (such as phenyl and naphthyl), an aromatic heterocyclic group (such as furyl, pyrazolyl, and pyridyl), an alkoxy group (such as methoxy, ethoxy, i-propoxy, and hexyloxy), an aryloxy group (such as phenoxy), an alkylthio group (such as methylthio and ethylthio), an arylthio group (such as phenylthio), an alkenyl group (such as vinyl and 1-propenyl), an acyloxy group (such as acetoxy, acryloyloxy, and methacryloyloxy), an alkoxycarbonyl group (such as methoxycarbonyl and ethoxycarbonyl), an aryloxycarbonyl group (such as phenoxycarbonyl), a carbamoyl group (such as carbamoyl, N-methylcarbamoyl, N,N-dimethylcarbamoyl, and N-methyl-N-octylcarbamoyl), and an acylamino group (such as acetylamino, benzoylamino, acrylamino, and methacrylamino). These substituents may be further substituted.

When there are a plurality of R¹⁰s, at least one of them is preferably a substituted alkyl group or a substituted aryl group.

### [Layer Formation]

The coat layer used in the present invention, and as needed, the hard coat layer, low refractive index layer, and other layers, is formed by coating a transparent substrate film with a coating liquid, heating and drying the coating, and then irradiating it with light and/or heating it as needed to cur the curable resin or monomer used to form each of the layers. This is how the various layers are formed.

There are no particular restrictions on the method for applying the layers of the film of the present invention, and any known method can be used, such as dip coating, air knife coating, curtain coating, roller coating, wire bar coating, gravure coating, extrusion coating (die coating) (see U.S. Pat. No. 2,681,294), or microgravure coating. Of these, a microgravure coating and die coating are preferred, and die coating is particularly preferable for supplying a film at high productivity.

Drying is preferably conducted under conditions such that the organic solvent concentration in the applied liquid film is 5 mass % or less, more preferably 2 mass % or less, and even more preferably 1 mass % or less, after drying.

The drying conditions may be affected by the thermal strength and conveyance speed of the substrate, the length of the drying step, and the like, but the content or the organic solvent is preferably as low as possible in order to prevent adhesion and obtain the desired film hardness. When no organic solvent is contained, the drying step may be omitted and the layer irradiated with UV rays immediately after its application.

The coat layer of the present invention may be heat treated to raise its crystallinity. A heat treatment temperature is preferably from 40° C. to 130° C., and the heat treatment duration can be suitably determined according to the required degree of crystallization, and is usually about 5 minutes to 48 hours.

Furthermore, if desired, one or both sides of the transparent substrate film can be subjected to surface treatment by an oxidation process, asperity process, or the like for the purpose of increasing adhesion between the transparent substrate film and the coat layer. Examples of the oxidation processes include corona discharge treatment, glow discharge treatment, chromic acid treatment (wet), flame treatment, hot air treatment, and ozone/ultraviolet irradiation treatment.

### [Saponification Treatment]

When the protective film of the present invention is used for a liquid crystal display device, it is disposed on the outermost surface of the display, such as by providing an adhesive layer on one side. If the transparent support is triacetyl cellulose, since triacetyl cellulose is used as the protective film for protecting the polarizing layer of a polarizing plate, the protective film of the present invention is preferably used directly as the protective film for polarizing plate to keep costs down.

If the protective film of the present invention is disposed on the outermost surface of a display, such as by providing a pressure-sensitive adhesive layer on one side, or is used directly as the protective film of a polarizing plate, a saponification treatment is preferably performed after the outermost layer has been formed over a transparent support in order to ensure satisfactory adhesion. The saponification treatment is performed by any known method, such as by dipping the film in an alkali solution for an appropriate length of time. After being dipped in the alkali solution, the film is preferably well washed with water or dipped in a dilute acid to neutralize the alkali component, so that the alkali component will not remain in the film.

The result of performing a saponification treatment is that the surface of the transparent support on the opposite side from the side having the outermost layer is hydrophilized.

A hydrophilized surface is particularly effective at improving adhesion to a deflecting film whose main component is a polyvinyl alcohol. Moreover, dust in the air tends not to stick to a hydrophilized surface, so little dust finds its way into the space between the deflecting film and the protective film during bonding to the deflecting film, so that spot defects caused by dust can be effectively prevented.

The saponification treatment is preferably performed such that the surface of the transparent support on the opposite side from the side having the outermost layer has a contact angle with water of 40° or less, more preferably 30° or less, and even more preferably 20° or less.

The specific method for the alkali saponification treatment can be selected from the following two methods 1 and 2. Method 1 is advantageous in that the treatment can be carried out by the same process as that for an ordinary triacetyl cellulose film, but since the saponification extends all the way to the surface having an optical function, there may be problems in that the film is deteriorated due to alkali hydrolysis of the surface, or the saponification treatment solution may remain behind and cause staining. When these problems occur, Method 2 is advantageous even though it entails a special process.

Method 1: After the formation of an optical function layer over the transparent support, the support is dipped at least once in an alkali solution, whereby the back of the film is saponified.

Method 2: Before or after an optical functional layer is formed over the transparent support, an alkali solution is applied to the opposite side of the protective film from the side where the optical functional layer is formed, and then the support is heated and washed with water and/or neutralized, whereby only the back of the film is saponified.

A polarizing plate in which the protective film of the present invention is used as a protective film for polarizing plate, and a liquid crystal display device in which this polarizing plate is used will now be described.

### (Polarizing Plate)

The polarizing plate is mainly comprised of a polarizer (polarizing film) and two protective films which sandwich the both sides of the polarizing film. The protective film of the present invention is preferably used for at least one of the two protective films sandwiching the both sides of the polarizing film. Because the protective film of the present invention also serves as the protective film for polarizing plate, the production cost of the polarizing plate can be reduced. Moreover, by using the protective film of the present invention as the outermost layer, a polarizing plate can be obtained with which ghost produced by outside light and so forth are prevented, and are excellent in scratch resistance and the like.

Examples of the polarizing films include an iodine-based polarizing film, a dye-based polarizing film featuring a dichroic dye, and a polyene-based polarizing film. An iodine-based polarizing film and a dye-based polarizing film are generally produced using a polyvinyl alcohol film.

Of the two protective films of the polarizer, the film other than the protective film for polarizing plate of the present invention is preferably an optical compensation film having an optical compensation layer that includes an optically anisotropic layer. The optical compensation film (phase differential film) is able to improve the viewing angle characteristics of a liquid crystal display screen.

The polarizing plate of the present invention is preferably disposed on the viewing side, which is the opposite side from the liquid crystal cell, when used in a liquid crystal display device or the like.

### (Liquid Crystal Display Device)

The protective film and polarizing plate of the present invention can be used to advantage in image display devices such as liquid crystal display devices, and is preferably used for the outermost layer of a display.

A liquid crystal display device has a liquid crystal cell and two polarizing plates disposed on both sides thereof, and the liquid crystal cell supports a liquid crystal between two electrode substrates. Further, one optically anisotropic layer may be disposed between the liquid crystal cell and one of the polarizing plates, or two optically anisotropic layers may be disposed between the liquid crystal cell and each of the two polarizing plates.

The liquid crystal cell is preferably in a TN (twisted nematic) mode, VA (vertical alignment) mode, OCB (optically compensated bend) mode, IPS (in-plane switching) mode, or ECB (electrically controlled birefringence) mode.

### <TN Mode>

In a liquid crystal cell in TN mode, rod-like liquid crystalline molecules are substantially horizontally aligned and further aligned in a twisted state between 60° and 120° when no voltage is applied.

A liquid crystal cell in TN mode is most frequently utilized as a color TFT liquid crystal display device, and is discussed in many publications.

### <VA Mode>

In a liquid crystal cell in VA mode, rod-like liquid crystalline molecules are substantially vertically aligned when no voltage is applied.

A liquid crystal cell in VA mode includes, in addition to (1) a liquid crystal cell in VA mode in the strict sense in which rod-like liquid crystalline molecules are substantially vertically aligned when no voltage is applied, but is substantially horizontally aligned when voltage is applied (see JP-A No. 2-176625), (2) a liquid crystal cell in multi-domained VA mode (MVA mode) for expanding the viewing angle (see SID 97, Digest of Tech. Papers, 28 (preprints) (1997), 845), (3) a liquid 2 5 crystal cell in a mode (n-ASM mode) in which rod-like liquid crystalline molecules are substantially vertically aligned when no voltage is applied, and undergoes twisted multi-domain alignment when voltage is applied (see Preprints of Liquid Crystal Forum of Japan [Nihon Ekishou Touronkai], 58 to 59 (1998), and (4) a liquid crystal cell in SURVIVAI, mode (published in LCD International 98).

### <OCB Mode>

A liquid crystal cell in OCB mode is a liquid crystal cell in bend alignment mode in which rod-like liquid crystalline molecules are aligned in substantially opposite directions (symmetrically) at the upper part and the lower part of the liquid crystal cell, and this is disclosed in U.S. Pat. Nos. 4,583,825 and 5,410,422. Since rod-like liquid crystalline molecules are aligned symmetrically between the upper part and the lower part of the liquid crystal cell, a liquid crystal cell in bend alignment mode has an optically self-compensating ability. Accordingly, this liquid crystal mode is also called an OCB (optically compensatory bend) liquid crystal mode. An advantage of a liquid crystal display device in bend alignment mode is that the response speed is faster.

### <IPS Mode>

A liquid crystal cell in IPS mode comprises a system of switching by applying a lateral electric field to a nematic liquid crystal, and is described in detail in Proc. IDRC (Asia Display '95), pp. 577 to 580 and pp. 707 to 710.

### <ECB Mode>

In a liquid crystal cell in ECB mode, rod-like liquid crystalline molecules are substantially horizontally aligned when no voltage is applied. The ECB mode is one of the liquid crystal display modes having the simplest structure, and is described in detail in JP-A No. 5-203946, for example.

As discussed above, the present invention can provide a protective film that achieves high surface hardness and low moisture permeability, a polarizing plate using the protective film, and a liquid crystal display device having high surface hardness and less light leakage using the polarizing plate.

### EXAMPLES

The present invention will now be described more specifically through examples, but embodiments of the present invention are not limited to or by these examples. All percentages and parts are by mass unless indicated otherwise.

The present invention will be described by using as a Example of a protective film in which a transparent substrate film is a cellulose acylate film, a low moisture-permeable layer containing a vinylidene chloride polymer, and an anti-glare layer having a thickness of 10 μm or more as a hard coat layer (anti-glare hard coat layer) are laminated in that order (hereinafter sometimes referred to as an anti-glare hard coat film).

### <Preparation of Vinylidene Chloride Polymer A>

Into a glass-lined pressure-resistant reactor, 100 parts of deionized water, 0.1 parts of sodium alkylsulfate, and 0.9 parts of sodium persulfate were loaded, the system was deaerated, and then the temperature of the contents was held at 50° C. In another vessel, 90 mass % of vinylidene chloride, 5 mass % of methacrylonitrile, and 5 mass % of methyl methacrylate were mixed to produce a monomer mixture. 0.6 parts of methacrylonitrile and 0.8 parts of itaconic acid were added to the reactor, after which 100 parts of the monomer mixture was added continuously, in the total amount, over a period of 16 hours. At this point 0.1 parts of sodium hydrogensulfite was also added continuously along with the monomers. After the total amount of monomer mixture had been added, the internal pressure immediately began to decrease, and the reaction was allowed to proceed until there was no further decrease in pressure, thereby obtained an aqueous dispersion of a vinylidene chloride polymer. Thirty grams of the aqueous dispersion of vinylidene chloride polymer was added dropwise at a little at a time under stirring to 100 g of a 3 mass % aqueous solution of calcium chloride that has been heated to 60° C., after which the agglomerate thus produced was washed with water and dried to obtain a white powder.

### <Preparation of Coating Liquid for Low Moisture-Permeable Layer>

The following composition was loaded in a mixing tank, and the components were dissolved under stirring to prepare coating liquids for low moisture-permeable layer A to C.

[Composition of Coating Liquid for Low Moisture-Permeable Layer A]

| | |
|---|---|
| vinylidene chloride polymer R204 | 12 parts |
| (Saran Resin R204, manufactured by Asahi Kasei | |
| Life & Living Corporation) | |
| tetrahydrofuran | 62 parts |
| toluene | 13 parts |
| methyl ethyl ketone | 13 parts |

[Composition of Coating Liquid for Low Moisture-Permeable Layer B]

| | |
|---|---|
| vinylidene chloride polymer A | 12 parts |
| tetrahydrofuran | 62 parts |
| toluene | 13 parts |
| methyl ethyl ketone | 13 parts |

[Composition of Coating Liquid for Low Moisture-Permeable Layer C]

| | |
|---|---|
| vinylidene chloride polymer F216 | 5 parts |
| (Saran Resin F216, manufactured by Asahi Kasei | |
| Life & Living Corporation) | |
| toluene | 9 parts |
| cyclohexanone | 18 parts |

### <Solubility Test of Vinylidene Chloride Polymer>

Two glass beakers each containing 100 g of cyclohexanone were prepared. 20 g of a powder of the vinylidene chloride polymer A produced as described above was loaded in one beaker, 36 g thereof was added to the other beaker, and then the beakers were put in a 25° C. thermostatic tank and stirred for 60 minutes, and the solubility was checked. The contents of the beaker containing 20 g of A had dissolved, but part of the contents of the beaker containing 36 g of A had not dissolved.

It was found from these results that the solubility of the vinylidene chloride polymer A in 100 g of cyclohexanone is 20 g or more to less than 36 g at 25° C.

A vinylidene chloride polymer R204 (Saran Resin R204, made by Asahi Kasei Life & Living) was tested in the same manner as the powder of the vinylidene chloride polymer A. The contents of the beaker containing 20 g of R204 had dissolved, but part of the contents of the beaker containing 36 g of R204 had not dissolved.

It was found from these results that the solubility of the Saran Resin R204 in 100 g of cyclohexanone is 20 g or more to less than 36 g at 25° C.

The vinylidene chloride polymer F216 (Saran Resin F216, manufactured by Asahi Kasei Life & Living Corporation) was tested in the same manner as the powder of the vinylidene chloride polymer A. The contents of the beaker containing 20 g of F216 and of the beaker containing 41 g of F216 had both dissolved.

It was found from these results that the solubility of the Saran Resin F216 in 100 g of cyclohexanone is 41 g or more at 25° C.

### <Preparation of Coating Liquid for Hard Coat Layer>

The following compositions were loaded in a mixing tank, and the components were dissolved under stirring to prepare a coating liquid for an anti-glare hard coat layer.

[Composition of Coating Liquid for Anti-Glare Hard Coat Layer HCL-1]

| | |
|---|---|
| UV curable resin (PETA, manufactured by Nippon Kayaku | 600.0 parts |
| Co., Ltd.) | |
| Irgacure 184 | 20.0 parts |
| toluene dispersion (30%) of crosslinked polystyrene | 17.0 parts |
| particles | |
| crosslinked acrylic-styrene particles having an average | 45.0 parts |
| size of 8 μm | |
| toluene | 392.0 parts |
| cyclohexanone | 98.0 parts |
| silicone oil “X-22-164C” | 0.1 parts |

### Example 1

### <Production of Protective Film>

### <<Application of Low Moisture-Permeable Layer>>

A commercially available cellulose acylate film (Fuji TAC TD80UF, manufactured by FUJIFILM Corporation; 1,340 mm wide and 80 μm thick) was drawn in roll form as a transparent substrate film, coated with the above-mentioned coating liquid for low moisture-permeable layer A by a bar coater at a conveyance speed of 30 m/minute, and dried for 1 minute at 100° C. 1,000 meters of this product was wound while being conveyed. The thickness of the low moisture-permeable layer was 2.0 μm.

### <<Application of Hard Coat Layer>>

The film coated with the low moisture-permeable layer produced as described above as a support (substrate) was played out in roll form, coated with a coating liquid for anti-glare hard coat layer (HCL-1) by a microgravure roll and a doctor blade at a conveyance speed of 15 m/minute, then dried for 150 seconds at 60° C., after which the coating layer was cured by irradiation with UV rays at a luminance of 400 mW/cm² and an irradiation dose of 250 mJ/cm² from a 160 W/cm air-cooled metal halide lamp (manufactured by Eyegraphics Co., Ltd.) under nitrogen purging so that the oxygen concentration was 1.0 vol % or less. The anti-glare layer thus formed was wound to produce a protective film (HCF-1) provided with an anti-glare hard coat layer. The average thickness of the anti-glare layer after curing was 12.0 μm.

The average thickness of the cured anti-glare layer (hard coat layer) of the anti-glare film in which an anti-glare layer (hard coat layer) was laminated over a low moisture-permeable layer as referred to in the Example means the thickness obtained by subtracting the average thickness of the low moisture-permeable layer when just the low moisture-permeable layer has been laminated, from the average value of thickness of combining the low moisture-permeable layer and the anti-glare layer after lamination of the anti-glare layer. Also, each thickness was confirmed by observing a cross section of the protective film under a scanning electron microscope, and finding the average value of 20 arbitrary points.

### Examples 2 to 9, Comparative Examples 2 and 3

### <Production of Protective Film>

Anti-glare hard coat films HCF-2 to HCF-9 and HCF-12 and HCF-13 were produced in the same manner as the anti-glare hard coat film HCF-1 in Example 1, except that the average thickness of the cured anti-glare layer and/or the average thickness of the low moisture-permeable layer were adjusted to the values given in Table 1.

### Example 10

### <Production of Protective Film>

An anti-glare hard coat film HCF-10 was produced in the same manner as the anti-glare hard coat film HCF-5 in Example 5, except that the coating liquid for low moisture-permeable layer was changed from the coating liquid for low moisture-permeable layer A to the coating liquid for low moisture-permeable layer B, and the average thickness of the cured anti-glare layer was adjusted to the value shown in Table 1.

### Comparative Example 1

An anti-glare hard coat film HCF-11 was produced in the same manner as the anti-glare hard coat film HCF-1 in Example 1, except that no low moisture-permeable layer was laminated, and the average thickness of the anti-glare layer was adjusted to 20 μm.

### Comparative Examples 4 and 5

Anti-glare hard coat films HCF-14 and HCF-15 were produced in the same manner as the anti-glare hard coat film HCF-1 in Example 1, except that the coating liquid for low moisture-permeable layer was changed from the coating liquid for low moisture-permeable layer A to the coating liquid for low moisture-permeable layer C, and the average thickness of the cured anti-glare layer was adjusted to the values shown in Table 1.

The anti-glare hard coat films HCF-1 to HCF-15 produced above were evaluated by the following methods (1) to (6), the results of which are given in Table 1.

### [Evaluation of Anti-Glare Hard Coat Film]

### (1) Mirror Reflectivity

A spectrophotometer (manufactured by JASCO) was used to measure the mirror reflectivity of respective anti-glare hard coat film samples at an incident angle of 5° and in a wavelength range of from 380 nm to 780 nm. For the evaluation, the average reflectivity at a wavelength range of from 450 nm to 650 nm was used.

### (2) Moisture Permeability (Moisture Permeability at 60° C. and 95% Relative Humidity)

The method described in “Physical Properties of Polymer [Koubunshi no Bussei] II,” (Polymer Experiment Course [Koubunshi Jikken Kouza] 4, Kyoritsu Shuppan Co., Ltd.), pp. 285-294: Measurement of Vapor Penetration Amount (mass method, thermometer method, vapor pressure method, adsorption method) was used to measure moisture permeability. Respective film samples according to the present invention were cut to a size of 70 mm in diameter, conditioned for moisture for 24 hours at 60° C. and 95% relative humidity, and the moisture contents per unit of surface area (g/m²) were calculated (moisture permeability={mass after moisture conditioning}−{mass before moisture conditioning}) using a moisture permeation cup according to JIS Z 0208. The moisture permeability value for a control cup containing no moisture absorbent was not corrected.

### (3) Pencil Hardness Evaluation

The pencil hardness evaluation set forth in JIS K 5400 was conducted as an index of scratch resistance. A light diffusing film was subjected to moisture conditioning at a temperature of 25° C. and a relative humidity of 60% for 2 hours, after which the test was performed under a load of 4.9N, using a 2 H to 5 H test pencil as set forth in JIS S 6006 and evaluated as follows. The highest hardness at which an “OK” rating was given was used as the evaluation value.

OK: from 0 to 1 scratch in evaluation of n=5

NG: 3 or more scratches in evaluation of n=5

### (4) Heat Resistance Evaluation

Respective anti-glare hard coat films were stored for 3 days at 105° C., and heat resistance thereof were evaluated in one of four ways according to the following criteria.

A: no discoloration

B: almost no discoloration

C: some discoloration seen

D: obvious discoloration seen

### (5) Particle-Free Layer Thickness

A cross section of the anti-glare film after the lamination of the anti-glare hard coat layer was imaged with a scanning electron microscope, magnified 5,000 times, this cross sectional micrograph was used to observe a length corresponding to 10 μm in the width direction of the sample, and the distance between the substrate interface of the low moisture-permeable layer and the portion where the fine particles were closest to the substrate was defined as the particle-free layer thickness. This operation was repeated 20 times, the particle-free layer thickness was sampled at 20 points, and the average value was defined as the average particle-free layer thickness.

### (6) Brittleness

A mandrel test was conducted according to JIS K 5600-5-1, and an evaluation was made as follows.

A: no cracks at 5 mm

B: cracks at 5 mm and no cracks at 8 mm

C: cracks at 8 mm

TABLE 1

| | | Low-moist. | | | | | | | | | |
|---|---|---|---|---|---|---|---|---|---|---|---|
| | | perm. layer | | Hard coat layer | | | Evaluations | | | | |
| | | | Film | | Film | PFL film | | Moist. perm. | | | |
| | Protective | Coating | thick. | Coating | thick. | thick. | Mirror | (g/m² per | Pencil | Heat | |
| | film | liquid | (μm) | liquid | (μm) | (μm) | ref. (%) | day) | hardness | Resistance | Brittleness |
| Example 1 | HCF-1 | A | 2.0 | HCL-1 | 10 | 2.0 | 2.0 | 130 | 4H | B | A |
| Example 2 | HCF-2 | A | 2.0 | HCL-1 | 20 | 2.0 | 2.5 | 140 | 5H | B | A |
| Example 3 | HCF-3 | A | 2.0 | HCL-1 | 25 | 2.0 | 2.7 | 150 | 5H | B | A |
| Example 4 | HCF-4 | A | 2.0 | HCL-1 | 30 | 2.0 | 2.7 | 160 | 5H | B | B |
| Example 5 | HCF-5 | A | 1.5 | HCL-1 | 20 | 1.5 | 2.5 | 180 | 5H | A | A |
| Example 6 | HCF-6 | A | 1.0 | HCL-1 | 20 | 1.0 | 2.5 | 250 | 5H | A | A |
| Example 7 | HCF-7 | A | 0.5 | HCL-1 | 20 | 0.5 | 2.5 | 450 | 5H | A | A |
| Example 8 | HCF-8 | A | 3.0 | HCL-1 | 20 | 3.0 | 2.7 | 110 | 5H | B | A |
| Example 9 | HCF-9 | A | 4.0 | HCL-1 | 20 | 4.0 | 2.7 | 90 | 5H | C | A |
| Example 10 | HCF-10 | B | 1.5 | HCL-1 | 20 | 1.5 | 2.5 | 180 | 5H | A | A |
| Comparative | HCF-11 | — | — | HCL-1 | 20 | 0 | 2.4 | 800 | 5H | A | A |
| Example 1 | | | | | | | | | | | |
| Comparative | HCF-12 | A | 0.4 | HCL-1 | 20 | 0.4 | 2.4 | 600 | 5H | A | A |
| Example 2 | | | | | | | | | | | |
| Comparative | HCF-13 | A | 2.0 | HCL-1 | 9 | 2.0 | 2.1 | 110 | 3H | B | A |
| Example 3 | | | | | | | | | | | |
| Comparative | HCF-14 | C | 2.0 | HCL-1 | 20 | 5.0 | 2.4 | 700 | 5H | B | A |
| Example 4 | | | | | | | | | | | |
| Comparative | HCF-15 | C | 2.0 | HCL-1 | 9 | 3.5 | 2.0 | 550 | 3H | B | A |
| Example 5 | | | | | | | | | | | |

PFL: Particle-free layer

The following is clear from the results in Table 1.

The hard coat films in which a hard coat layer having a thickness of 10 μm or more was formed over a low moisture-permeable layer having a thickness of 0.5 μm or more which is formed by a polyvinylidene chloride resin having a low solubility in cyclohexanone, had the high surface hardness and low moisture permeability (moisture permeation was good at 500 g/m² per day or less). In such a system, the thickness of the layer containing no particles (particle-free layer thickness) is equal to the thickness of the low moisture-permeable layer, and was between 0.3 μm and 3.0 μm.

On the other hand, the hard coat films in which the hard coat layer having a thickness of 10 μm or more was formed over the low moisture-permeable layer formed by a polyvinylidene chloride resin having high solubility in cyclohexanone, had the high surface hardness and moisture permeation of 500 g/m² per day or more, thus adequate moisture permeability was not obtained.

In such a system, the thickness of the layer containing no particles (particle-free layer thickness) increased with respect to the thickness of the low moisture-permeable layer, and was outside the range of 0.3 μm to 3.0 μm.

When the low moisture-permeable layer was formed from a vinylidene chloride polymer, discoloration occurred by heating, but this discoloration could be minimized by keeping the thickness of the low moisture-permeable layer to 3.0 μm or less.

### (Production of Polarizing Plate)

A polarizing film was produced by adsorbing iodine to a drawn polyvinyl alcohol film, a commercially available wide-viewing angle film (Wide View Film SA 12B, manufactured by FUJIFILM Corporation) was subjected to a saponification treatment, and then a surface thereof on which the liquid crystal layer was not laminated was bonded to one surface of the polarizing film by using a polyvinyl alcohol adhesive.

Furthermore, a roll of the protective film HCF-1 produced in Example 1 was similarly subjected to a saponification treatment, and then a surface thereof on which the coat layer was not formed was bonded to the other surface of the polarizing film by using a polyvinyl alcohol adhesive, thereby producing a polarizing plate P-1.

Also, polarizing plates P-2 to P-15 were produced in the same manner as the polarizing plate P-1, except that the rolled protective film HCF-1 was changed to HCF-2 to HCF-15.

### (Production of Liquid Crystal Display Device)

The polarizing plate provided to a liquid crystal display device using a TN-mode liquid crystal cell (MRT-191S manufactured by Mitsubishi Electric) was peeled off, and in its place the respective polarizing plates P-1 to P-15 of the present invention were bonded to the device with an adhesive, such that the coat layer was on the outside (on the viewing side) and that the transmission axis of the polarizing plate coincided with that of the polarizing plate originally bonded to the device, thereby producing liquid crystal display devices LCD-1 to LCD-15. The liquid crystal display devices were evaluated for the following characteristics. The results are given in Table 2.

### <Ghost Evaluation>

Respective liquid crystal display devices were illuminated at an angle of 45° from the normal line of the surfaces of the liquid crystal display devices toward the horizontal plane, using a bare, unlouvered fluorescent lamp (8,000 cd/m²), and the extent of ghosts produced by the fluorescent lamp when observed from a direction of −45° were evaluated on the following scale.

### [Evaluation Scale]

A: The presence of the fluorescent lamp could not be detected, and the entire screen looked white.

B: The silhouette of the fluorescent lamp could not be made out at all, but the presence of the fluorescent lamp could be detected.

C: The silhouette of the fluorescent lamp could be faintly seen, but there was almost no ghost.

D: The fluorescent lamp did produce ghost, although blurry.

E: The fluorescent lamp ghost was obvious.

<Evaluation of Light Leakage after High-Humidity Treatment (Evaluation of Peripheral Unevenness)>

The liquid crystal display device was treated at 60° C. and 90% RH for 50 hours, and was then left at 25° C. and 60% RH for 2 hours, after which the liquid crystal display device was made to give a black display, and the light leakage from the front of the device was visually evaluated by several observers in a darkroom, on the basis of the following evaluation scale.

### [Evaluation Scale]

A: No light leakage was seen.

B: Light leakage was less than 5 mm from the edge.

C: Light leakage was 5 mm or more to less than 10 mm from the edge.

D: Light leakage was 10 mm or more from the edge.

TABLE 2

| | Protective film | | | | Light |
|---|---|---|---|---|---|
| | | Moisture | | | leakage after |
| | | permeation | Polarizing | | high-humidity |
| | Film | (g/m² per day) | plate | Ghost | treatment |
| LCD-1 | HCF-1 | 130 | P-1 | C | A |
| LCD-2 | HCF-2 | 140 | P-2 | C | A |
| LCD-3 | HCF-3 | 150 | P-3 | C | A |
| LCD-4 | HCF-4 | 160 | P-4 | C | A |
| LCD-5 | HCF-5 | 180 | P-5 | C | A |
| LCD-6 | HCF-6 | 250 | P-6 | C | B |
| LCD-7 | HCF-7 | 450 | P-7 | C | C |
| LCD-8 | HCF-8 | 110 | P-8 | C | A |
| LCD-9 | HCF-9 | 90 | P-9 | C | A |
| LCD-10 | HCF-10 | 180 | P-10 | C | A |
| LCD-11 | HCF-11 | 800 | P-11 | C | D |
| LCD-12 | HCF-12 | 600 | P-12 | C | D |
| LCD-13 | HCF-13 | 110 | P-13 | C | A |
| LCD-14 | HCF-14 | 700 | P-14 | A | D |
| LCD-15 | HCF-15 | 550 | P-15 | A | D |

The following is clear from the results in Table 2.

The light leakage after high-humidity treatment of a TN-mode liquid crystal display device in which an anti-glare film was bonded to the outermost surface corresponds to the moisture permeation of the anti-glare film, and the lower the moisture permeation was, the less light leakage there was.

Moreover, there was very little background ghost in any of the liquid crystal display devices LCD-1 to LCD-10 equipped with the anti-glare hard coat film in the present invention, and display quality was high.

In both the anti-glare hard coat film HCF-11, in which no low moisture-permeable layer was formed, and the anti-glare hard coat film HCF-12, in which the thickness of the low moisture-permeable layer was 0.4 μm, moisture permeation was high and a great deal of light leakage was noted.

In the anti-glare hard coat film HCF-13, in which the thickness of the low moisture-permeable layer was 2.0 μm and the thickness of the hard coat layer was 9 μm, there was little light leakage, but the surface hardness according to an object of the present invention could not be attained.

Furthermore, in the liquid crystal display devices LCD-14 and LCD-15, which were equipped with the anti-glare hard coat films HCF-14 and HCF-15 having a particle-free layer thickness of more than 3 μm, there was an increase in light scattering at the surface, the fluorescent lamp produced ghost, and the entire surface of the liquid crystal display device looked white, which was undesirable.

Next, the present invention will be described by giving an Example of a protective film (anti-glare hard coat film) in which the amount of fine particles contained in the hard coat layer was varied, using an anti-glare layer (anti-glare hard coat layer) having a thickness of 10 μm or more.

### Examples 11 to 13

### <<Preparation of Coating Liquid for Anti-Glare Hard Coat Layer>>

Coating liquids for anti-glare hard coat layers HCL-2 to HCL-4 were prepared by changing the components of the coating liquid for anti-glare hard coat layer HCL-1 in Example 5 so that the amount of crosslinked acrylic-styrene particles was the amount given in Table 3.

### <<Application of Low Moisture-Permeable Layer>>

In the same manner as in Example 5 above, a commercially available cellulose acylate film (Fuji TAC TD80UF, manufactured by FUJIFILM Corporation; 1,340 mm wide and 80 μm thick) was drawn in roll form as a transparent substrate film, coated with the above-mentioned coating liquid for low moisture-permeable layer A at a conveyance speed of 30 m/minute by a bar coater, and dried for 1 minute at 100° C. 1,000 meters of this product was wound while being conveyed. The thickness of the low moisture-permeable layer here was 1.5 μm.

### <<Application of Anti-Glare Hard Coat Layer>>

The film coated with the low moisture-permeable layer produced as described above as a support (substrate) was played out in roll form, coated with a coating liquid for anti-glare hard coat layer HCL-2 by a microgravure roll and a doctor blade at a conveyance speed of 15 m/minute, then dried for 150 seconds at 60° C., after which the coating layer was cured by irradiation with UV rays at a luminance of 400 mW/cm² and an irradiation dose of 250 mJ/cm² from a 160 W/cm air-cooled metal halide lamp (manufactured by Eyegraphics Co., Ltd.) under nitrogen purging so that the oxygen concentration was 1.0 vol % or less. The anti-glare layer thus formed was wound to produce an anti-glare hard coat film HCF-16. The average thickness of the anti-glare layer after curing was 20 μm.

An anti-glare hard coat films HCF-17 and HCF-18 were respectively produced in the same manner as the anti-glare hard coat film HCF-16, except that the coating liquid was respectively changed to coating liquids for anti-glare hard coat layers HCL-3 and HCL-4.

### Comparative Examples 6 to 9

Anti-glare hard coat films HCF-19 to HCF-22 were respectively produced in the same manner as the anti-glare hard coat films HCF-5 and HCF-16 to HCF-18 respectively produced in Examples 5 and 11 to 13, except that the thickness of the anti-glare hard coat layer were changed as shown in Table 3.

The anti-glare hard coat films HCF-5 and HCF-16 to HCF-22 produced above were evaluated by the above methods (1) to (5), the results of which are given in Table 3.

TABLE 3

| | | Low-moist. | | | | | | | | | |
|---|---|---|---|---|---|---|---|---|---|---|---|
| | | perm. layer | | Hard coat layer | | | | Evaluations | | | |
| | | | Film | | Particle | Film | Particle- | Mirror | Moisture | | |
| | Protective | Coating | thick. | Coating | amt. | thick. | free layer | ref. | permeation | Pencil | |
| | film | liquid | (μm) | liquid | (parts) | (μm) | thick. (μm) | (%) | (g/m² per day) | hardness | Brittleness |
| Example 5 | HCF-5 | A | 1.5 | HCL-1 | 7.5 | 20 | 1.5 | 2.5 | 180 | 5H | A |
| Example 11 | HCF-16 | A | 1.5 | HCL-2 | 15 | 20 | 1.5 | 2.5 | 150 | 5H | A |
| Example 12 | HCF-17 | A | 1.5 | HCL-3 | 30 | 20 | 1.5 | 2.5 | 130 | 5H | A |
| Example 13 | HCF-18 | A | 1.5 | HCL-4 | 40 | 20 | 1.5 | 2.5 | 120 | 4H | A |
| Comparative | HCF-19 | A | 1.5 | HCL-1 | 7.5 | 9 | 1.5 | 2.1 | 110 | 3H | A |
| Example 6 | | | | | | | | | | | |
| Comparative | HCF-20 | A | 1.5 | HCL-2 | 15 | 9 | 1.5 | 2.1 | 110 | 3H | A |
| Example 7 | | | | | | | | | | | |
| Comparative | HCF-21 | A | 1.5 | HCL-3 | 30 | 9 | 1.5 | 2.1 | 105 | 3H | A |
| Example 8 | | | | | | | | | | | |
| Comparative | HCF-22 | A | 1.5 | HCL-4 | 40 | 9 | 1.5 | 2.1 | 105 | 3H | A |
| Example 9 | | | | | | | | | | | |

The following is clear from the results in Table 3.

In the anti-glare hard coat film in which the anti-glare hard coat layer was laminated over the low moisture-permeable layer, when the thickness of the anti-glare hard coat layer was 10 μm or more (i.e. 20 μm), moisture permeation could be lowered by increasing the amount of particles contained in the binder. Considering that pencil hardness tended to decrease when the amount of particles contained in the binder was 40 parts, the amount of particles was most preferably from 20 parts to 35 parts.

On the other hand, almost no effect of decreasing moisture permeation was seen when the thickness of the anti-glare hard coat layer was less than 10 μm.

Therefore, the anti-glare hard coat layer preferably had a thickness of 10 m or more, and an amount of particles of from 20 parts to 35 parts.

Next, the present invention will be described by giving an example of an anti-glare antireflective hard coat film having a configuration of a low moisture-permeable layer, anti-glare layer, and low-refractive index layer, in that order.

### Example 14

### <<Application of Low Moisture-Permeable Layer>>

In the same manner as in Example 4 above, a commercially available cellulose acylate film (Fuji TAC TD80UF, manufactured by FUJIFILM Corporation; 1,340 mm wide and 80 μm thick) was drawn in roll form as a transparent substrate film, coated with the coating liquid for low moisture-permeable layer A by a bar coater at a conveyance speed of 30 m/minute, and dried for 1 minute at 100° C. 1,000 meters of this product was wound while being conveyed. The thickness of the low moisture-permeable layer here was 1.5 μm.

### <<Preparation of Coating Liquid for Hard Coat Layer>>

A mixture was made from an urethane acrylate (100 parts of urethane acrylate consisting of a pentaerythritol acrylate and hydrogenated xylene diisocyanate); polyol (meth)acrylate (49 parts dipentaerythritol hexaacrylate, 24 parts of pentaerythritol triacrylate, and 41 parts of pentaerythritol tetraacrylate; and a (meth)acrylic polymer having an alkyl group containing two or more hydroxyl groups (59 of parts (meth)acrylic polymer having a 2-hydroxyethyl group and a 2,3-dihydroxypropyl group; PC 1097, manufactured by Dainippon Ink & Chemicals, Incorporated). A hard coat-forming material was prepared by diluting 30 parts of PMMA particles having an average particle diameter of 8 μm (refractive index: 1.49), 0.5 parts of a reactive leveling agent, and 5 parts of a polymerization initiator (Irgacure 184) based on 100 parts of the total resin components as mixed above with a mixed solvent of butyl acetate and ethyl acetate in a mixing ratio of 55:45 (ethyl acetate accounted for 45% of the total solvent) so that the solids concentration would be 55%. The reactive leveling agent was a copolymer of dimethylsiloxane, hydroxypropylsiloxane, 6-isocyanate hexyl isocyanuric acid, and an aliphatic polyester in a molar ratio of 6.3:1.0:2.2:1.0, respectively.

### <<Application of Hard Coat Layer>>

The film coated with a low moisture-permeable layer produced as described above as a support (substrate) was played out in roll form, coated by a bar coater, and heated for 1 minute at 100° C. to dry the coating film.

The coating film was then irradiated with UV rays at an accumulated light intensity of 300 mJ/cm² from a metal halide lamp to cure the coating and form a hard coat layer having a thickness of 20 μm and the anti-glare hard coat film (HCF-23) pertaining to this Example.

### Example 15

Next, an anti-reflection layer was laminated over the anti-glare hard coat film HCF-23 to produce the anti-glare, antireflective hard coat film (HCF-24) pertaining to this Example.

### <<Preparation of Coating Liquid for Anti-Reflection Layer>>

[Preparation of Coating Liquid for Anti-Reflection layer LNL-1]

First, a siloxane oligomer having an average molecular mass (ethylene glycol-equivalent) of 500 to 10,000 (Colcoat N103 manufactured by Colcoat Co., Ltd.; solids content of 2 mass %) was provided as a material for forming the anti-reflection layer, and then measured its number average molecular mass. The number average molecular mass was found to be 950.

Also, a fluorine compound having a number average molecular mass (polystyrene-equivalent) of 5,000 or more and a fluoroalkyl structure and a polysiloxane structure (Opstar JTA105, manufactured by JSR Corporation; solids content of 5 mass %) was provided, and then measured its number average molecular mass. The polystyrene-equivalent number average molecular mass was found to be 8,000.

JTA105A (made by JSR Corporation; solids content of 5 mass %) was used as a curing agent.

Next, a coating liquid for anti-reflection layer LNL-1 was prepared by mixing 100 parts of Opstar JTA105, 1 part of JTA105A, 590 parts of Colcoat N103, and 151.5 parts of butyl acetate.

### <<Application of Anti-Reflection Layer>>

The coating liquid for anti-reflection layer LNL-1 prepared above was applied to the hard coat layer of the anti-glare hard coat film HCF-22 by a die coater in the same width as the hard coat layer, and the coating was dried and cured by heating for 3 minutes at 120° C. to form an anti-reflection layer (a low-refractive index layer having a thickness of 0.1 μm and a refractive index of 1.43) and produce an anti-glare antireflective hard coat film HCF-24.

### Example 16

Next, the anti-glare antireflective hard coat film HCF-25 pertaining to this Example was produced by laminating an anti-reflection layer containing hollow particles over the anti-glare hard coat film HCF-23.

### <<Preparation of Coating Liquid for Anti-Reflection Layer>>

### [Preparation of Coating Liquid for Anti-Reflection Layer LNL-2]

A coating liquid for anti-reflection layer LNL-2 was prepared by dispersing 100 parts of dipentaerythritol acrylate, 15 parts of a silicone polymer having a methacryloxypropyl group and a butyl group, 2.5 parts of hexanediol acrylate, 6 parts of a Lucirin-type photopolymerization initiator, and hollow, spherical silicon oxide ultrafine particles having a diameter of 60 nm and that have been surface treated and hydrophobized with a silane coupling agent having an acrylic group, were dispersed in a mixed solvent of IPA, MIBK, butyl cellosolve, and toluene (80/9/10.5/0.5) so that the solids content would be 3%.

### <<Application of Anti-Reflection Layer>>

The coating liquid for anti-reflection layer LNL-2 prepared above was applied to the hard coat layer of the anti-glare hard coat film HCF-23 by a die coater in the same width as the hard coat layer, and the coating was dried and cured by heating for 3 minutes at 120° C. to form an anti-reflection layer (a low-refractive index layer having a thickness of 0.1 μm and a refractive index of 1.43) and produce an anti-glare antireflective hard coat film HCF-25.

The anti-glare hard coat film HCF-23 and the anti-glare antireflective hard coat films HCF-24 and HCF-25 produced above were evaluated by the above methods (2), (3), (5) and the following method (7), the results of which are given in Table 4.

### (7) Integrated Reflectivity

A spectrophotometer (manufactured by JASCO) was used to measure the integrated reflectivity of respective anti-glare hard coat film samples at an incident angle of 50 and in a wavelength range of from 380 nm to 780 nm. For the evaluation, the average reflectivity at a wavelength range of from 450 nm to 650 nm was used.

TABLE 4

| | | Low-moist. | | | | | | | | | |
|---|---|---|---|---|---|---|---|---|---|---|---|
| | | perm. layer | | Hard coat layer | | | | | Evaluation | | |
| | | | Film | | Particle | Film | Particle- | Anti- | Integrated | Moisture | |
| | Protective | Coating | thick. | Coating | amt. | thick. | free layer | reflection | reflectivity | permeation | Pencil |
| | film | liquid | (μm) | liquid | (parts) | (μm) | thick. (μm) | layer | (%) | (g/m² per day) | hardness |
| Example | HCF-23 | A | 1.5 | HCL-5 | 30 | 20 | 1.5 | — | 4.0 | 130 | 5H |
| 14 | | | | | | | | | | | |
| Example | HCF-24 | A | 1.5 | HCL-5 | 30 | 20 | 1.5 | LNL-1 | 2.5 | 130 | 5H |
| 15 | | | | | | | | | | | |
| Example | HCF-25 | A | 1.5 | HCL-5 | 30 | 20 | 1.5 | LNL-2 | 2.5 | 130 | 5H |
| 16 | | | | | | | | | | | |

The following is clear from the results in Table 4.

By laminating an anti-reflection layer over the anti-glare hard coat film, it was possible to produce an anti-glare antireflective hard coat film having high surface hardness, low moisture permeation, and low integrated reflectivity.

### <Production of Polarizing Plate>

A polarizing film was produced by adsorbing iodine to a drawn polyvinyl alcohol film, a commercially available wide-viewing angle film (Wide View Film SA 12B, manufactured by FUJIFILM Corporation) was subjected to a saponification treatment, and then a surface thereof on which the liquid crystal layer was not laminated was bonded to the one surface of the polarizing film by using a polyvinyl alcohol adhesive.

Furthermore, a roll of the protective film HCF-23 produced in Example 1 was similarly subjected to a saponification treatment, and then a surface thereof on which the coat layer was not formed was bonded to the other surface of the polarizing film by using a polyvinyl alcohol adhesive, thereby producing a polarizing plate P-23.

Polarizing plates P-24 and P-25 were respectively produced in the same manner as the polarizing plate P-23, except that the anti-glare hard coat film HCF-23 was changed to HCF-24 and HCF-25, respectively.

### [Production of Liquid Crystal Display Device]

The polarizing plate provided to a liquid crystal display device using a TN-mode liquid crystal cell (MRT-191S, manufactured by Mitsubishi Electric) was peeled off, and in its place the respective polarizing plates P-23 to P-25 of the present invention were bonded to the device with an adhesive, such that the coat layer was on the outside (on the viewing side) and that the transmission axis of the polarizing plate coincided with that of the polarizing plate originally bonded to the device, thereby producing liquid crystal display devices LCD-23 to LCD-25. These were evaluated in the same manner as the above-mentioned liquid crystal display devices LCD-1 to LCD-15. The results are given in Table 5.

TABLE 5

| | Protective film | | | | Light |
|---|---|---|---|---|---|
| | | Moisture | | | leakage after |
| | | permeation | Polarizing | | high-humidity |
| | Film | (g/m² per day) | plate | Ghost | treatment |
| LCD-23 | HCF-23 | 130 | P-23 | C | A |
| LCD-24 | HCF-24 | 130 | P-24 | B | A |
| LCD-25 | HCF-25 | 130 | P-25 | B | A |

The following is clear from the results in Table 5.

The TN-mode liquid crystal display devices LCD-23 to LCD-25, in which the anti-glare hard coat film HCF-23 and the anti-glare antireflective hard coat films HCF-24 and HCF-25 used in the present invention were respectively bonded onto the outermost surface, had very little light leakage after high-humidity treatment.

Moreover, the liquid crystal display device LCD-23 having the anti-glare hard coat film of the present invention had very little background ghost, and particularly, the liquid crystal display devices LCD-24 and LCD-25 having anti-glare antireflective hard coat films of the present invention respectively had extremely light background ghost, and high display quality.

What is claimed is:

1. A protective film comprising:
a transparent substrate film;
a low moisture-permeable layer over one surface of the transparent substrate film; and
a hard coat layer over the low moisture-permeable layer, the hard coat layer having an average thickness of 10 μm or more,
wherein the protective film has a moisture permeability at 60° C. and 95% relative humidity of 500 g/m² per day or less.

2. The protective film according to claim 1, wherein the low moisture-permeable layer has an average thickness of from 0.5 μm to 3.0 μm.

3. The protective film according to claim 1, wherein the hard coat layer comprises fine particles, and an average thickness of an area where the fine particles are not contained from an interface between the transparent substrate film and the low moisture-permeable layer is from 0.3 μm to 3.0 μm.

4. The protective film according to claim 1, wherein the hard coat layer has an average thickness of 15 μm or more.

5. The protective film according to claim 1, wherein the low moisture-permeable layer comprises a resin having repeating units derived from a chlorine-containing vinyl monomer.

6. The protective film according to claim 5, wherein the chlorine-containing vinyl monomer is vinylidene chloride.

7. The protective film according to claim 5, wherein the resin having repeating units derived from a chlorine-containing vinyl monomer is a vinylidene chloride copolymer consisting of 88 mass % to 93 mass % of vinylidene chloride and 7 mass % to 12 mass % of a monomer which can be copolymerized with the vinylidene chloride and which contains 40 mass % or more of methacrylonitrile.

8. The protective film according to claim 5, wherein the resin having repeating units derived from a chlorine-containing vinyl monomer has a solubility of 1 g to 40 g in 100 g of cyclohexanone at 25° C.

9. The protective film according to claim 1, wherein the pencil hardness at a load of 4.9 N is 4H or more according to a pencil hardness evaluation method set forth in JIS K 5400.

10. The protective film according to claim 1, wherein the hard coat layer comprises an ionizing radiation-curing composition as a binder.

11. The protective film according to claim 1, wherein the hard coat layer comprises fine particles in an amount of 5 mass % to 40 mass % in a binder.

12. The protective film according to claim 11, wherein at least a part of the fine particles is resin particles.

13. The protective film according to claim 12, wherein the resin particles have an average particle diameter of 4 μm to 15 μm.

14. The protective film according to claim 1, wherein the transparent substrate film comprises cellulose acylate.

15. A polarizing plate comprising
a polarizer; and
a protective film provided over at least one surface of the polarizer, wherein the protective film comprises:
a transparent substrate film;
a low moisture-permeable layer over one surface of the transparent substrate film; and
a hard coat layer over the low moisture-permeable layer, the hard coat layer having an average thickness of 10 μm or more,
wherein the protective film has a moisture permeability at 60° C. and 95% relative humidity of 500 g/m² per day or less.

16. A liquid crystal display device comprising:
a liquid crystal cell; and
a polarizing plate comprising a polarizer and a protective film provided over at least one surface of the polarizer,
wherein the protective film comprises:
a transparent substrate film;
a low moisture-permeable layer over one surface of the transparent substrate film; and
a hard coat layer over the low moisture-permeable layer, the hard coat layer having an average thickness of 10 μm or more,
wherein the protective film has a moisture permeability at 60° C. and 95% relative humidity of 500 g/m² per day or less.
